(19) United States
(12) Patent Application Publication
(10) Pub. No.: US 2016/0350778 A1
(43) Pub. Date: Dec. 1, 2016

(54) ONLINE SOLAR MARKETPLACE PROVIDING CARBON REDUCTION INCENTIVES AND TRACKING

(71) Applicant: GEOSTELLAR, INC., Martinsburg, WV (US)

(72) Inventors: David A. LEVINE, Shepherdstown, WV (US); Richard B. Deal, Shenandoah Junction, WV (US); Jeremy T. Dobrzanski, Shepherdstown, WV (US); Mark C. Wirt, Shepherdstown, WV (US)

(21) Appl. No.: 15/167,542

(22) Filed: May 27, 2016

Related U.S. Application Data
(60) Provisional application No. 62/168,601, filed on May 29, 2015.
(60) Provisional application No. 62/325,358, filed on Apr. 20, 2016.

(51) Int. Cl. G06Q 30/02; G06Q 50/06

(52) U.S. Cl. CPC G06Q 30/0208; G06Q 50/06

(57) ABSTRACT

Computer-implemented systems and methods are disclosed for facilitating generation of carbon credits to offset greenhouse gas emissions. In an embodiment, carbon emissions reduction targets for a defined time period are first received from a sponsor. A campaign is initiated for the sponsor that includes a sponsor promotion and targets selected properties and/or regions. One or more broad market simulations are then run on the targeted properties or regions to estimate an average solar energy production per property. The promotion is adjusted for each targeted property based on the property's estimated energy production compared to the average solar energy production across the targeted properties. Installation of solar energy systems on one or more of the targeted properties is then facilitated through the sponsor's campaign and promotion, and carbon credits may be provided to the sponsor that correspond to energy produced by the installed solar energy systems.

### CROSS REFERENCE TO RELATED APPLICATIONS

This application claims the benefit of U.S. Provisional Application No. 62/168,601, filed May 29, 2015, and U.S. Provisional Application No. 62/325,358, filed Apr. 20, 2016, which are incorporated by reference in their entirety.

### BACKGROUND

Climate change has been globally recognized as an urgent problem in need of mitigation. To combat greenhouse gas (GHG) emissions, modern corporate governance often requires a published sustainability plan with details on greenhouse gas emissions related to the facilities and vehicles owned and operated by the company (Scope 1), emissions produced by the power plants that generate the electricity consumed by direct company operations and facilities (Scope 2) and indirect emissions related to the supply chain, distribution and travel (Scope 3). At the end of each reporting period, progress toward the reduction of emissions is reported for each scope.

The responsibility for sustainability initiatives is typically in the hands of a Corporate Social Responsibility or Sustainability Officer. These positions are generally under-resourced and considered cost centers. To make progress against goals, the sustainability team must influence business units to adopt products, systems and processes that reduce emissions.

Sustainability teams find that meeting total emissions reduction goals is very difficult. As the business itself grows, the expanding operations increase emissions. For this reason, progress is often expressed as reductions in emissions intensity, not overall carbon emissions. Emissions intensity can be reduced primarily through energy efficiency projects, on-site solar installation and conversion to electric vehicles.

Scope 3 emissions are a particularly intractable problem. For example, hotels need to encourage, not reduce, guest travel, businesses require employees to commute to the office and travel for meetings and conferences, and ecommerce companies need to ship products around the world.

When sustainability teams cannot reduce emissions, they will sometimes offset emissions through the purchase of VCUs (Verified Carbon Units) or RECs (Renewable Energy Certificates). It is commonly accepted that VCUs and RECs are only a last resort, and should only be applied to emissions that cannot be reduced. Because there is no established market for VCUs, prices are typically very low, ranging from $2.00 for agricultural offsets to $6.00 for more charismatic programs such as wind farms and biogas plants. In some cases, VCUs can be sold for as much as $10.00, $12.00 or $15.00. The benefit of offsets is that they can be applied to emissions in any scope.

RECs are similar to offsets, except they can only be applied to the Scope 1 and Scope 2 emissions directly related to the consumption of electricity. Rather than purchasing RECs on an exchange, companies and individuals might simply pay a bit more for “100% clean” electricity from a competitive retail electricity provider, who purchases and retires the RECs. SRECs (Solar Renewable Energy Credits) are a specific type of REC that can be registered and sold by solar project owners. SRECs typically fetch higher prices than RECs, as some states have solar carve-outs in their Renewable Portfolio Standards (RPS). SREC typically range from $50 to $500 per MWh, with an average of $150 per MWh (http://www.solsystemscompany.com/our-resources/srec-prices-and-knowledge). This is approximately equivalent to $267 per ton CO2e.

Offsets (and RECs) have several issues. Many people consider the practice of purchasing offsets objectionable, in that it is paying someone else to reduce their emissions as a substitute for actively reducing one's own. Another issue is that offsets are fundamentally unsustainable. The purchaser is paying for something with no inherent value, so the purchase of the offset appears as a tax on a good or service, without any associated income. Companies that have offered offsets to consumers at checkout, to cover shipping or travel emissions for example, have seen little adoption. This is likely because the source of emissions reduction is so far removed from the purchasing of the offset. The emissions threat and reduction both seem very abstract when a few cents are added to a transaction cost.

As long as reducing emissions are a cost center, genuine sustainability will not be achieved. What is needed is an electronic marketplace that enables entities to directly contribute to generating carbon offsets while receiving additional revenue through referral and solar energy origination fees.

### SUMMARY

Computer-implemented systems and methods are disclosed for facilitating generation of carbon credits to offset greenhouse gas emissions. In an embodiment, carbon emissions reduction targets for a defined time period are first received from a sponsor. A campaign is initiated for the sponsor that includes a sponsor promotion and targets selected properties and/or regions. One or more broad market simulations are then run on the targeted properties or regions to estimate an average solar energy production per property. The promotion is adjusted for each targeted property based on the property's estimated energy production compared to the average solar energy production across the targeted properties. Installation of solar energy systems on one or more of the targeted properties is then facilitated through the sponsor's campaign and promotion.

In an embodiment, solar energy production of each installed solar energy system is monitored. Carbon credits may then be provided to the sponsor that correspond to the amount of carbon dioxide equivalent (CO₂e) reduction attributed to each installed solar energy system.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating energy providers involved in a solar energy offering, according to an embodiment.

FIG. 2 is a diagram illustrating an example pricing model for a solar energy offering, according to an embodiment.

FIG. 3 is a diagram illustrating an example solar energy simulation on a particular property, according to an embodiment.

FIG. 4 is a diagram illustrating elements that may be altered when running a new simulation, according to an embodiment.

FIG. 5 is a diagram illustrating interaction between users collaborating on a solar energy simulation, according to an embodiment.

FIG. 6 is a diagram that illustrates two example displays of information on a tablet device and mobile phone device based on output from an online energy marketplace, according to an embodiment.

FIG. 7 is a diagram illustrating market analysis based on market simulations of particular geopolitical regions, according to an embodiment.

FIGS. 8A and 8B are example methods for presenting a solar energy offering to a user of a solar energy marketplace, according to an embodiment.

FIG. 9 illustrates an example method for ranking, sorting and analyzing individual properties within a geographic or geopolitical region, according to an embodiment.

FIG. 10 is a diagram illustrating scope 1, scope 2, and scope 3 greenhouse gas (GHG) emissions categories, according to an embodiment.

FIG. 11 is a diagram illustrating an example pricing model for a solar energy offering incorporating marketplace sponsors, according to an embodiment.

FIG. 12 is an example method for calculating the cost of a solar energy offering that includes a sponsor promotion, according to an embodiment.

FIG. 13 is an example method for facilitating generation of carbon credits to offset a sponsor's carbon emissions, according to an embodiment.

FIG. 14 is a diagram illustrating an example system for providing a solar energy marketplace, according to an embodiment.

FIG. 15 is a diagram illustrating an example computing device, according to an embodiment.

FIG. 16A depicts an example interface for an online solar marketplace, according to an embodiment.

FIG. 16B depicts a map illustrating solar potential of a particular region, according to an embodiment.

FIGS. 16C and 16D depict example interfaces for viewing details of a solar energy offering, according to an embodiment.

FIGS. 16E and 16F depict example interfaces for entering and altering parameters of a solar energy simulation, according to an embodiment.

FIG. 16G depicts an example interface for viewing and monitoring details of a selected solar energy system installation, according to an embodiment.

FIG. 16H depicts an example interface for viewing estimated energy production of a solar energy system, according to an embodiment.

FIG. 16I depicts an example interface for displaying the estimated costs of solar energy compared to conventional electricity costs, according to an embodiment.

FIGS. 16J, 16K, and 16L depict example interfaces for communicating among users of an online solar marketplace, according to an embodiment.

FIG. 17 depicts an example interface for entering solar energy base pricing information in an online solar marketplace, according to an embodiment.

FIGS. 18A and 18B depict example interface for entering an equipment offering in an online solar marketplace, according to an embodiment.

FIG. 19 depicts an example interface for entering a financing offering in an online solar marketplace, according to an embodiment.

FIG. 20A depicts an example interface for viewing metrics associated with a partner of a solar energy marketplace, according to an embodiment.

FIGS. 20B and 20C depict an example interface for adding a partner or sponsor to a solar energy marketplace, according to an embodiment.

FIG. 21A depicts an example interface for adding a new campaign to a solar energy marketplace, according to an embodiment.

FIGS. 21B and 21C depict an example interface for entering promotions into a solar energy marketplace, according to an embodiment.

FIGS. 22A, 22B, 22C, and 22D illustrate use of an application programming interface (API) for a solar energy marketplace, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

### Example Online Solar Energy Marketplace

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Climate change has been globally recognized as an urgent problem in need of mitigation. The United Nations Environment Programme refers to climate change mitigation as efforts to reduce or prevent emission of greenhouse gases (GHG), which can involve using new technologies and renewable energies, making older equipment more energy efficient, or changing management practices or consumer behavior. (Climate Change Mitigation, United Nations Environment Programme, www.unep.org.) Multiple global initiatives have been put in place to reduce emission of GHG, such as the United Nations Framework Convention on Climate Change, which was first established in 1992 with the objective of stabilizing greenhouse gas concentrations in the atmosphere at a level that will prevent human interference with the climate system. (About UNFCCC, United Nations Framework Convention on Climate Change, newsroom.unfccc.int.) The recent Conference of Parties held in 2015 further addressed goals of accelerating the reduction of GHG emissions and analyzing current mitigation pledges compared with emission pathways that limit the increase in global average temperature to an acceptable level. (Transforming our world: the 2030 Agenda for Sustainable Development, United Nations Division for Sustainable Development (Oct. 21, 2015), sustainabledevelopment.un.org; Adoption of the Paris Agreement: Proposal by the President, United Nations Framework Convention on Climate Change (Dec. 12, 2015), unfccc.int.)

Many corporations publish sustainability plans with details on GHG emissions related to the facilities and vehicles owned and operated by the company (Scope 1), emissions produced by the power plants that generate the electricity consumed by direct company operations and facilities (Scope 2) and indirect emissions related to the supply chain, distribution and travel (Scope 3). In one embodiment, an online solar marketplace allows sponsors to profitably replace scope 1, 2, and 3 emissions by enrolling their employees, customers, and suppliers in a shared scope of effort. Sponsors can specify carbon emission reduction amounts to be achieved in online tool. The online solar marketplace automatically calculates and provides cost-saving promotions to corresponding groups of employees, customers, and suppliers to attain specified sponsor carbon emission reductions. The program enhances the brand of the sponsor, develops long-term loyalty on the part of the customer and saves participants money on electricity bills. The marketplace allows sponsors for the first time to specify carbon emission reductions and provide incentives for marketplace participants to price solar installations to meet the specified carbon emissions.

The value of a solar energy system offering on a particular rooftop is a function of both the levelized cost of energy (LCOE) of the electricity produced by the solar array and the cost of the conventional grid electricity that is displaced. LCOE can differ from rooftop to rooftop with the same equipment configuration due to differing intensity of solar radiation on each rooftop. The LCOE may take into account one or more of the following factors: cost of various equipment configurations, efficiency of various equipment configurations, cost of installation, quality of installation, cost of financing, form of financing, or other factor impacting cost.

In an embodiment, a solar energy marketplace quantifies and compares the potential value of a unique solar energy offering for a particular rooftop, including equipment, installation, and/or financing, by performing simulations of each solar offering on the rooftop. The rooftop may have a unique incidental solar radiation signature based on characteristics such as atmosphere, shade, slope and orientation. The value of each solar energy offering may then be compared against conventional electricity from the power grid.

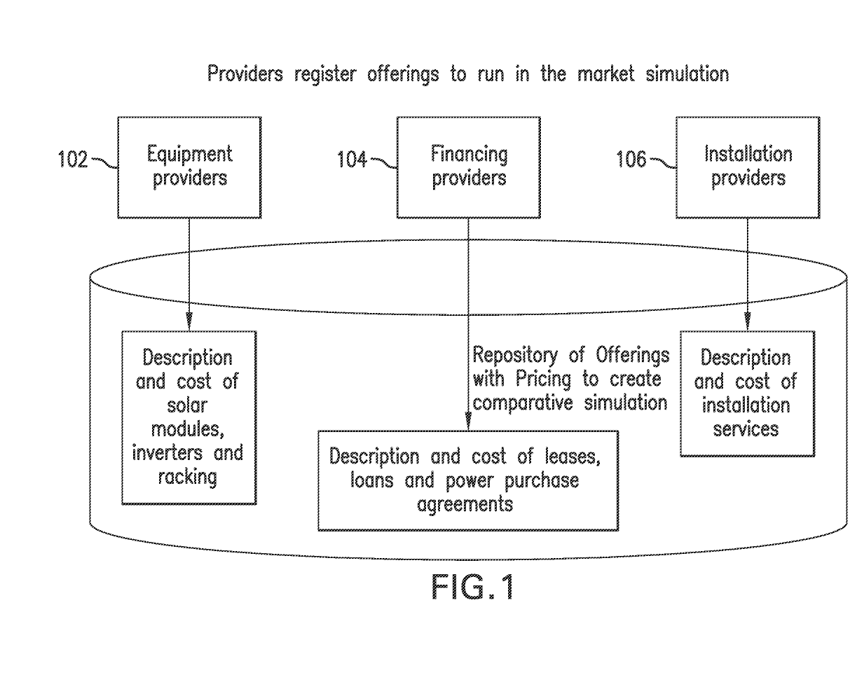

FIG. 1 is a diagram illustrating energy providers involved in a solar energy offering, according to an embodiment. In an embodiment, the solar energy marketplace enables energy providers to input solar energy equipment, installation, and financing offerings. These providers may be categorized by type, for example equipment providers, installation providers, and financing providers.

Equipment providers 102 may be manufacturers or distributors of solar energy equipment. In an embodiment, the equipment provided may include, but is not limited to, solar modules (panels), inverters, racking and mounting systems, and/or balance of system (BoS). Solar modules may produce electrical current from incidental solar radiation. Inverters may convert the electricity produced from direct current (DC) to alternating current (AC) for consumption by businesses or residences. Racking and mounting systems may be used to secure the solar modules to a rooftop. BoS may include cabling, basic installation hardware, and/or other peripherals.

Installation providers 106 (also referred to herein as installers) may provide the following services such as, but not limited to, site verification and assessment, system design, rebate applications, permitting, engineering, and/or planning.

Financing providers 104 (also referred to herein as financing companies) may provide various financing programs for a solar energy offering such as, but not limited to, leases, power purchase agreements (PPAs), and loans. For lease programs, a financing company and associated investors may own, monitor, and maintain the solar energy equipment installed on the roof of a property, receive incentives (e.g., solar energy tax rebates), and charge the property owner a fixed monthly lease amount for the installed solar energy array. The lease payments may be competitively priced to be less than the monthly rate of energy displaced by the array. For PPAs, a financing company and associated investors may monitor and maintain the solar energy equipment installed on the roof of a property, receive incentives, and charge the property owner for the power produced by the solar energy array. The new cost of electricity may again be competitively priced to be less than the cost of energy displaced by the array. For loan agreements, a financing company may lend money to a property owner to acquire and install solar equipment. Interest may be charged on the loan, which again may be priced competitively to be less than the cost of energy displaced by the solar energy array.

In an embodiment, providers may provide offerings in more than one category. For example, an equipment manufacturer or distributor may offer installation and/or financing, an installer may offer equipment and/or financing, and a financing company may offer equipment and/or installation. In this case, a provider may be included in more than one type category.

Each offering may have different specifications and costs. These may be updated by the provider or by an administrator of the marketplace system.

In an embodiment, an integrated solar energy offering may combine equipment, installation and financing in an authorized combination. Certain financing companies may only provide leases, PPAs and loans for systems that include certain equipment configurations. Equipment companies may also be restricted to only provide equipment to certain authorized installers. Certain installers may represent certain equipment and financing companies.

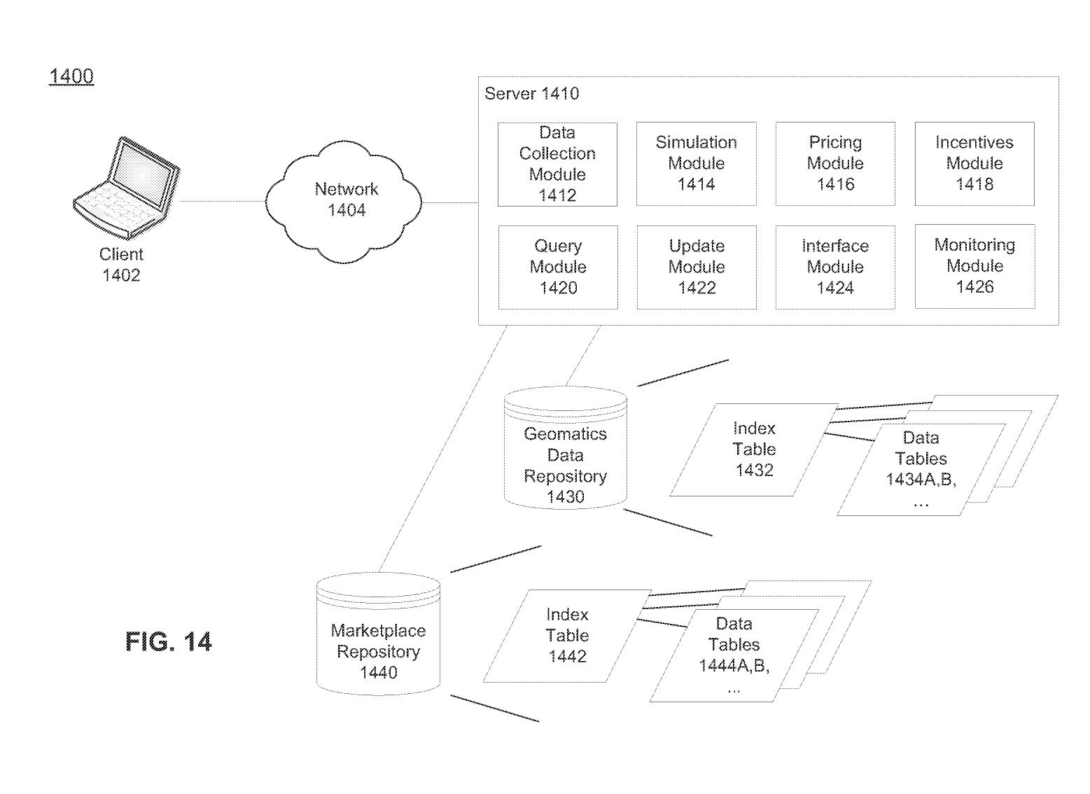

In an embodiment, each provider may price their elements separately, and the marketplace may combine them in an integrated offering. Pricing of offerings may also include a time period for which the offer is valid. Additionally, pricing of offerings may reflect the system size, roof type, and other factors, as described further below. Equipment and service prices may be stored in marketplace repository, such as marketplace repository 1440 of FIG. 14, according to an embodiment.

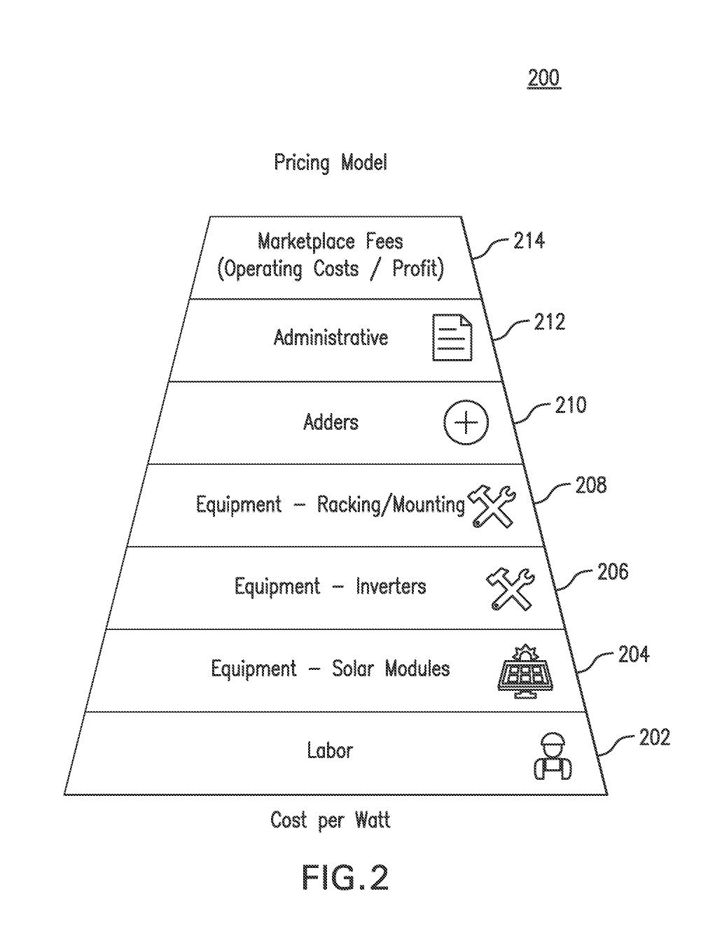

FIG. 2 is a diagram illustrating an example pricing model for a solar energy offering, according to an embodiment. A solar energy offering may include labor costs 202, equipment costs 204-208, adder costs 210, administrative costs 212, and marketplace fees 214. Costs 202 through 214 represent a pricing model for a solar energy offering, according to an embodiment. The total installed cost (e.g., purchasing and installing a solar array as specified in the solar energy offering) may be determined by combining costs 202-214. In an embodiment, the cost of the solar energy offering may be normalized based on solar array capacity (e.g., per Watt) in order to directly compare options involving systems of different size. By allowing multiple providers to participate in the solar energy offering, prices may reflect local or national market rates due to pricing transparency among providers. Without such an online solar marketplace, price discrimination may occur due to a lack of consumer knowledge.

Labor costs 202 may include typical installation costs associated with a solar energy system, such as but not limited to, site verification and assessment, system design, and equipment installation. Equipment costs 204 may be associated with solar modules (panels) included in the system. Equipment costs 206 may be associated with inverters included in the system. Equipment costs 208 may be associated with racking and/or mounting systems to secure the solar modules to a rooftop. Administrative costs 212 may include, but are not limited to, permitting, auditing, and paperwork costs.

In a market where solar energy is less competitive with conventional electricity, for example due to low conventional electricity rates, poor renewable energy incentives, or low insolation (incidental solar radiation), offerings may be priced more competitively. Additionally, a large solar energy system, for example larger than 6 kW, may cost less per Watt than a smaller system due to fixed overhead for setup, logistics, and soft costs that may be incurred. Price may also be reduced through lower cost components, such as polycrystalline modules and string inverters.

An example system might be priced at $1.62 per Watt if the system is purchased for cash. In an embodiment, $0.92 of this cost may be allocated for equipment and $0.70 may be allocated for labor and installation. For an average 6.5 kW system, a total of $10,530 in cash may be paid, with $5,980 going to the equipment provider and $4,550 going to the installer.

In an embodiment, each equipment and installation provider may enter their base price for a standard configuration. Equipment and installation providers may then enter the price of adders 210, which represent additional costs that may be incurred. These may be fixed cost or calculated on a per-Watt basis. Example adders may include, for example, the following:

| Per Watt Adder | Per Watt Charge |
|---|---|
| Monocrystalline modules, which are more efficient | $0.18 |
| Microinverters, which are attached to each panel | $0.30 |
| for module-level monitoring and control | |
| Tile roof (more expensive mounting) | $0.25 |
| Landscape panel orientation | $0.05 |
| High Roof (above 20 ft with no staging area) | $0.05 |
| Steep Roof (30 degrees+, for each 5 degree | $0.05 |
| increment) | |
| Ground Mount | $0.65 |
| Tilt-up modules (for flat roof) | $0.05 |
| Mileage (above 50 miles from radius from business) | $0.01 |

Example fixed cost adders may include, for example, the following:

| Fixed Adder | Amount |
|---|---|
| Site verification, assessment and monitor installation | $250 |
| Filing for rebates and incentives | $500 |
| System design, permitting, engineering and plan sets | $700 |
| Subarrays, each additional | $150 |
| Main Breaker Derate | $300 |
| AC Combiner | $400 |
| Relocate circuits to subpanel | $300 |
| Supply Side Tap | $400 |
| Meter Housing Upgrade | $400 |
| 200 A Service Upgrade | $2,000 |
| Feet of Conduit over 100′ | $4.00/ft |
| Ground Mount over 250′ | $17.00/ft |

In an embodiment, promotions may also be created, such that a specific price may be offered for a particular time-period. Descriptions of equipment, and the equipment's suitability for particular environments, may be entered by providers or system administrators, or uploaded directly from a provider's system. Similarly, descriptions of installers may be included to distinguish the capabilities of the installer.

Examples of equipment description fields that may be added may include, but are not limited to, name of equipment manufacturer, model of equipment, brand logo, equipment origination (e.g., country where made), size and/or power of solar module, equipment warranty, and equipment efficiency rating.

Examples of installer description fields that may be added may include, but are not limited to, name of installer, brand logo, company values, company origin, leadership biographies, number of years of solar installation experience, number of completed projects, workmanship warranty, insurance coverage, number of employees, and company revenue.

In an embodiment, the pricing model may take into account additional discounts, rebates, federal incentives, and/or local incentives to reduce the installed cost of the solar energy offering. For example, residential renewable energy tax credits may be taken into account to estimate the installed cost of the solar energy offering.

Once a price for a solar energy offering has been established via the pricing model, financing may be added. For a lease or a PPA, a look-up table of monthly payment rates may be created based on the requirements of the fund, which typically include IRR (internal rate of return) and other factors. From the fund criteria, a look up table may be created with system size, cost, location and production estimates. The lease pricing may be recalculated based on an upfront payment that may be made by the property owner. Loans may be calculated based on the interest, term, and fees associated with the amount that is borrowed.

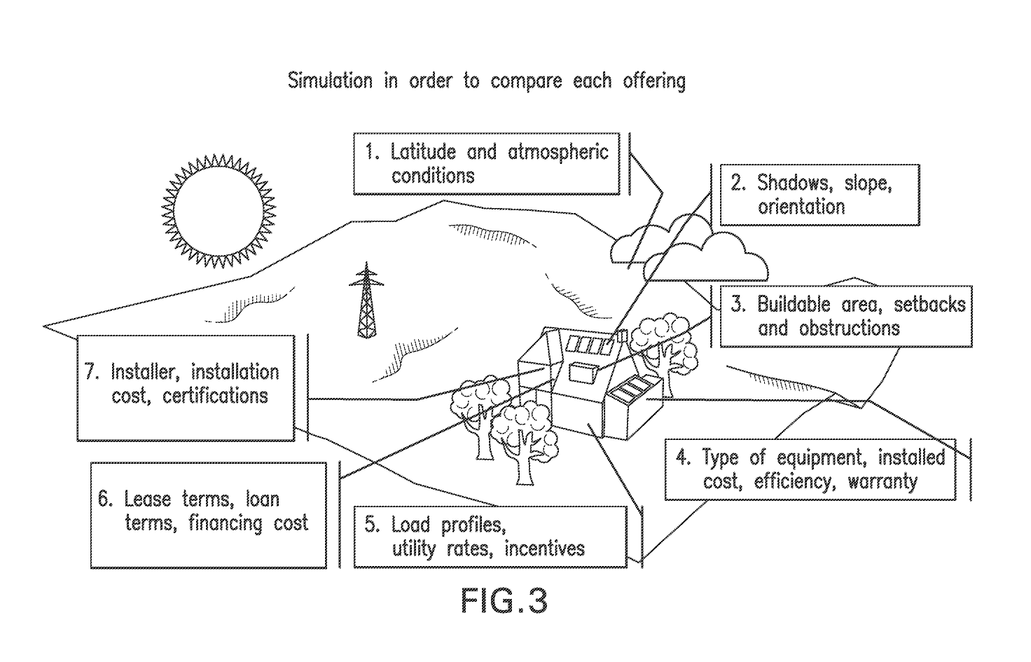

In an embodiment, each offering represents a solar array with a particular performance profile, installed cost, financing program and other characteristics. A solar energy simulation and energy production analysis may be run for each offering on each individual property, as discussed further with respect to FIG. 3. Simulations can be run in bulk on a plurality of properties, or on-demand for a particular property. Additionally, part of the simulation may be run in advance, and the rest on-demand.

For example, the energy production part of the simulation may be performed on every property in a broad region. The results may then be stored in a data repository, such as marketplace repository 1440 of FIG. 14. These energy production simulations may be computed based on incidental solar radiation and buildable area of each roof facet. In an embodiment, the cost of the equipment and the financing options may then be computed ad hoc when an address is queried.

FIG. 3 is a diagram illustrating an example solar energy simulation on a particular property, according to an embodiment. The property may be represented by a 3D model, with roof facets that may be extracted using remote sensing technologies, for example, from LiDAR or stereo imagery. Vegetation may also be separated from impermeable surfaces using, for example, LiDAR, color infrared, four-band or multi-spectral imagery.

Detailed installation models and planning may be performed on the virtual property models to produce an optimal system design for best solar performance. These may also be made code compliant, as, in an embodiment, the marketplace may be coupled to a building code database and permitting database via a network, such as the Internet.

When running a simulation, various factors may be taken into account to determine the best design and offering. As illustrated in FIG. 3, these factors may include, but are not limited to, latitude and atmospheric conditions, roof shadows, slope and orientation, buildable area, setbacks, and obstructions, equipment type, installed cost, efficiency, and warranty, load profiles, utility rates, available incentives, lease terms, loan terms, financing costs, and installer certifications. In one embodiment, the design process may be fully automated, with different equipment and financing options being fit to the 3D property model, or scene, and each option being compared, for example by a genetic algorithm, to determine the best system design is available.

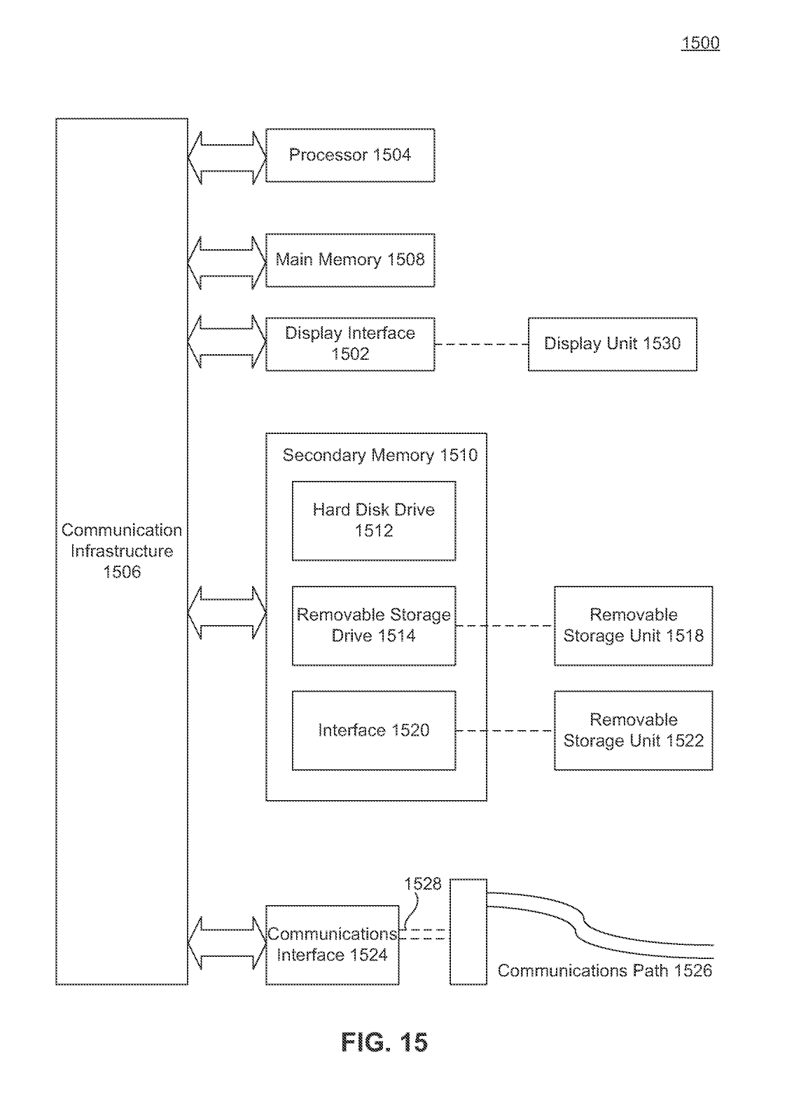

In another embodiment, a property scene may be constructed from ground-level photographs taken from a consumer mobile device or GPS-enabled camera. In this embodiment, a user may use a mobile device with location systems and camera to take photographs of roof installation sites and surrounding areas from multiple ground location points. Dimensional estimations may be performed by a computing device, such as the computing system of FIG. 15, and augmented with manual input from the user.

In both embodiments, a 3D scene model that includes elevation and positional data for both the site of the solar array and surrounding area may be reconstructed. In various embodiments, the user may select the desired roof or ground surface, facet or facets for solar installation, or this may be determined by the system based on available incidental solar radiation. The system may arrange the components of the solar array, or they may be manipulated by the user. Permitting and code compliance may be validated and enforced in the 3D model. These may include setbacks from the edges of the roof, resistance to wind and support under the weight of snow. In an embodiment, permitting and code compliance values may be available in the system through an API.

Equipment elements such as racking, mounting, size and efficiency of panels and efficiency of inverters may be used to determine specific performance, which may be optimized in the simulation. In an embodiment, a full plan-set for installation may be output to a user device.

In an embodiment, the system design may be overlaid on the photographs. The system design may also be presented in augmented reality systems, for example GOOGLE GLASS, for use by installers. The presentation may also be viewed by the property owner as an overlay in a photograph or superimposed on the roof through the augmented reality system.

In an embodiment, an energy production analysis may be performed on data and energy production estimates derived from the solar energy simulation. A levelized cost of energy may be determined for the life of the solar energy system or another period of time based on the energy production estimates and expected cost of conventional electricity. Conventional electricity costs may be calculated based on average electricity costs in one or more regions, adjusted based on an estimated rate of energy inflation. A total monthly or overall cost for a solar energy offering may then be computed based on the levelized cost of energy for solar and the expected conventional electricity costs. In an embodiment, the total cost of the solar energy offering may include both solar energy costs and supplemental conventional electricity costs (e.g., the amount of energy needed in addition to solar energy production). Supplemental conventional electricity costs may be calculated as a proportion of the expected cost of conventional electricity for the additional amount of energy needed.

In an embodiment, the levelized cost of energy for the solar energy system may take into account federal and/or local incentives, such as solar alternative energy credits. For example, the solar energy system may generate renewable energy credits based on an amount of carbon dioxide equivalent (CO₂e) emissions reduced. In a non-limiting example, energy produced by the solar energy system may be registered with an appropriate registry in exchange for Solar Renewable Energy Certificates (SRECs), which can then be sold to offset costs of solar energy. The expected revenue generated from selling SRECs over a period of time may be factored into the calculated levelized cost of energy. One of skill in the art will recognize that other forms of renewable energy credits may be acquired via energy produced by the solar energy system, such as but not limited to, Verified Carbon Units (VCUs).

In an embodiment, the summary results of the solar energy simulation and energy production analysis may be presented to a user of the marketplace in a comparison table. The offerings may be compared to average conventional electricity costs without solar, based on the estimated rate of energy inflation. This may inform a user of the savings achieved by installing a solar energy system. A user of the marketplace may also manually enter the amount of their average monthly electricity bill and their conventional electricity provider to re-compute comparison data.

According to an embodiment, conventional electricity information presented to the user may include the average estimated monthly electricity bill during a period of time, e.g., the average monthly bill over the course of the next 25 years if a solar energy system is not installed, based on the estimated energy inflation rate. The expected annual energy inflation rate for a region may also be presented, which may be estimated through historical data retrieved from an external third-party, such as the Energy Information Administration. Information presented may additionally include the total cost of electricity during a period of time, e.g., during the next 25 years, based on current conventional electricity bills and estimated energy inflation rates.

Each solar energy offering may be compared against the option of using only conventional electricity (e.g., not installing solar) or against another competitive offering. Each offering, for example, may display metrics unique to the offering, such as but not limited to, the new estimated monthly energy bill, the monthly savings compared to conventional electricity, the total savings compared to conventional electricity during a period of time, e.g., during a 25 year period or during the term of a lease or PPA, and the amount of initial cash outlay required to install the solar energy system.

Additional details of the offering may also be presented, such as but not limited to, the financing company (if any), the equipment type, the origin of the equipment, the installer, and the time frame of a promotion.

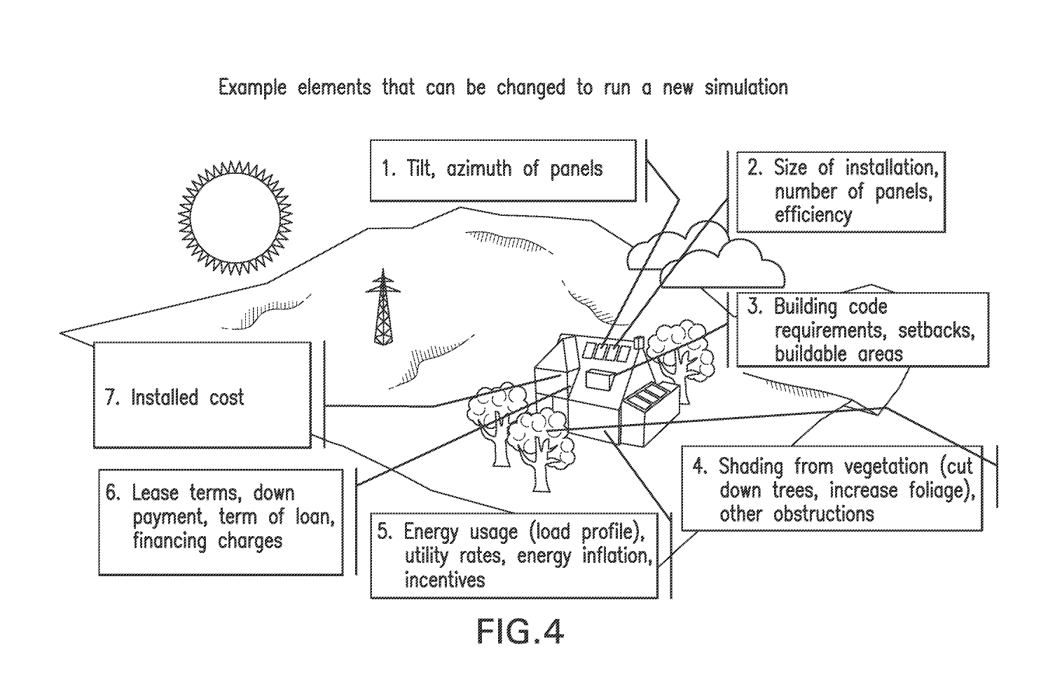

FIG. 4 is a diagram illustrating elements that may be altered when running a new simulation, according to an embodiment. In an embodiment, it may be desirable to change certain aspects of the offering or the property in order to compare results of offerings based different simulations. Changes may be manually prompted by a user, or multiple simulations may be automatically run based on common or expected feature variations.

As depicted in FIG. 4, example elements that may be changed when running new simulations include, but are not limited to, tilt and azimuth of solar panels, size of installations, number and efficiency of panels, building code requirements, setbacks, buildable areas, shading from vegetation (for example, a user may decide to cut down a tree or increase foliage), energy usage (e.g., load profile), utility rates, energy inflation, available or applicable incentives, lease terms, down payment, term of loan, financing charges, and installed cost. Installed cost may be particularly important for a cash sale, in which the property owner may only have a certain amount of money to invest. In an embodiment, if the installed cost is changed by a user, the system size and other elements may be automatically changed to reflect the adjusted cost. In an embodiment, the current amount of the property owner's monthly utility bill and the utility provider may also be changed.

These alterations and customizations may generate new offering results. Once the modifications are made and new results are produced, the details and or summary of the offering may then be compared with other offerings and with the conventional electricity (e.g., “without solar”) option. In an embodiment, information on monthly payments, the payback period and rate, monthly savings, incentives, carbon reduction and other factors may be presented. In an embodiment, a partial list of details for the initial offerings and customized offerings that are presented to a user may include, but are not limited to: The average price of a kWh of conventional electricity for the property over the next 25 years (e.g., the life of a solar panel) or another period of time, average monthly payments for conventional electricity, the estimated annual increase in conventional electricity rates, the average cost of a kWh of solar electricity produced by the solar panels over the 25 year life of the panels accounting for degradation and other factors, average monthly financing payments for the solar energy system, the annual increase of solar energy costs (e.g., in the case of a lease with an escalator clause), the total cost of the solar energy system (including financing charges, if any), the down payment due on a lease or loan, the term of a loan, the interest rate of a loan, the percentage of the electricity bill offset by solar energy, the total monthly payments during a period of time (e.g., solar and conventional utility costs combined), the total savings for the offering as compared against conventional electricity costs, the total electricity costs over the 25 year life of the solar panels or the term of a lease or PPA (e.g., solar and conventional utility costs combined), payments due over the life of the solar energy system, such as upfront payments, loan payments and lease payments, applicable national, state, local and rate-payer incentives, such as rebates, tax credits and performance-based incentives, and the installed cost as described above with respect to FIG. 2.

The system size/capacity (nominal system power) in kW and energy production over a period of time (e.g., 25 years) in kWh or MWh may also be presented. In an embodiment, carbon pollution offset by the solar energy system, shown in barrels of oil, tons of coal, or another metric, may additionally be presented. The effect of solar energy in offsetting carbon dioxide equivalent emissions may be equated to, for example, the number of new trees that would need to be planted, aluminum cans that would need to be recycled, miles of air travel offset, or miles of car travel offset for comparison purposes. In various embodiments, these details may be presented as lists, tables, graphs, or any combination thereof.

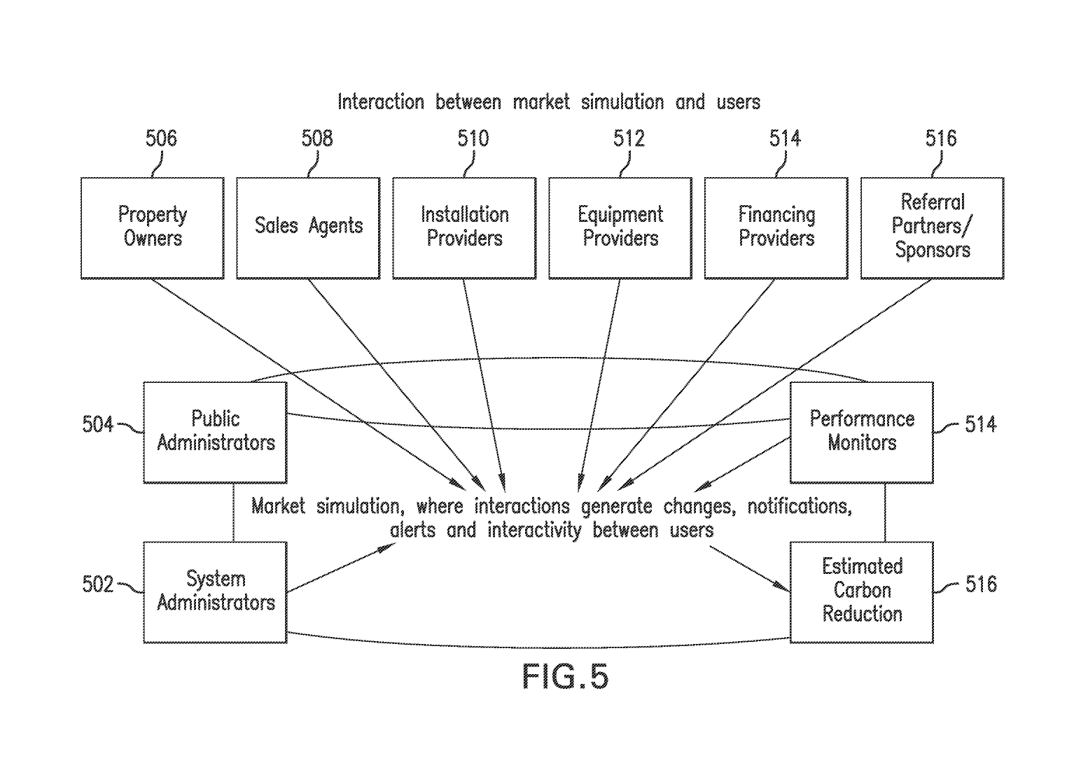

FIG. 5 is a diagram illustrating interaction between users collaborating on a solar energy simulation, according to an embodiment. During the sales and marketing process, during closing and contracting, permitting and installation, and during ongoing monitoring and maintenance, solar energy offerings and simulations in the online solar marketplace provide a communications vehicle.

In an embodiment, the online solar marketplace may include several user types, such as but not limited to, system administrators 502, public administrators 504, property owners 506, sales agents 508, solar providers 510, and referral partners and sponsors 516. Public administrators 504 may include, for example, permitting administrators and interconnection authorities. Sales agent 508 may include, for example, remote sales agents and field sales agents. Installation providers 510, equipment providers 512, and financing providers 514 may provide various installation, equipment, and financing offerings to the marketplace that may be used to perform solar energy simulations, as described previously.

In various embodiments, users may initiate and participate in dialogues within the marketplace, share documents, and link to documents and messaging systems outside the marketplace, including affixing electronic signatures on documents to close sales in the marketplace. In an embodiment, threaded dialogues may be maintained.

Alerts and notifications may also be generated by activities of other users or changes to a simulation. In an embodiment, relevant parties may be automatically notified through electronic communications when appropriate based on a user's actions, or through specific input requests. Aggregated information related to user behavior may also be collected for analytic purposes.

Once a system is commissioned, the solar panels and other appliances may be attached to communicate data to the online solar marketplace to inform installers, sales agents and property owners on their working condition, and to compare performance with other users and connected systems. The marketplace may implement various performance monitors 518 to track performance of each installed solar energy system.

In an embodiment, the estimated carbon equivalent (CO₂e) reduction 520 attributed to a solar energy offering may be calculated based on each simulation. This estimate may be used by property owners when selecting an offering, or by sponsors to evaluate carbon reduction efforts.

The marketplace may estimate the amount of CO₂e reduction for a particular solar energy offering based on the total amount of energy produced over a period of time. For example, a 10 kW solar energy system at a particular geolocation may produce approximately 100,000 kWh of energy over 10 years. The estimated energy production may be derived from one or more simulations run for the 10 kW system.

In an embodiment, the geolocation of the solar energy system may be mapped to state and/or county Federal Information Processing Standard (FIPS) codes. These codes may then be correlated to data in a carbon footprinting database that contains emissions data for particular geographic regions. The estimated energy output of the solar energy system may be converted to an amount of CO₂e offset based on data retrieved from the carbon footprinting database. For example, the Environmental Protection Agency maintains an Emissions & Generation Resource Integrated Database (eGRID), which contains emissions and energy conversion information for particular geographic regions. In an embodiment, a FIPS code mapped from the geolocation of the solar energy system may be correlated to a region defined by eGRID. The estimated solar energy output (e.g., 100,000 kWh) may then be converted into metric tons of CO₂e using conversion information retrieved from eGRID. This allows the marketplace to present an estimate of the CO₂e reduction that will be produced by installing a solar energy system at a particular geolocation.

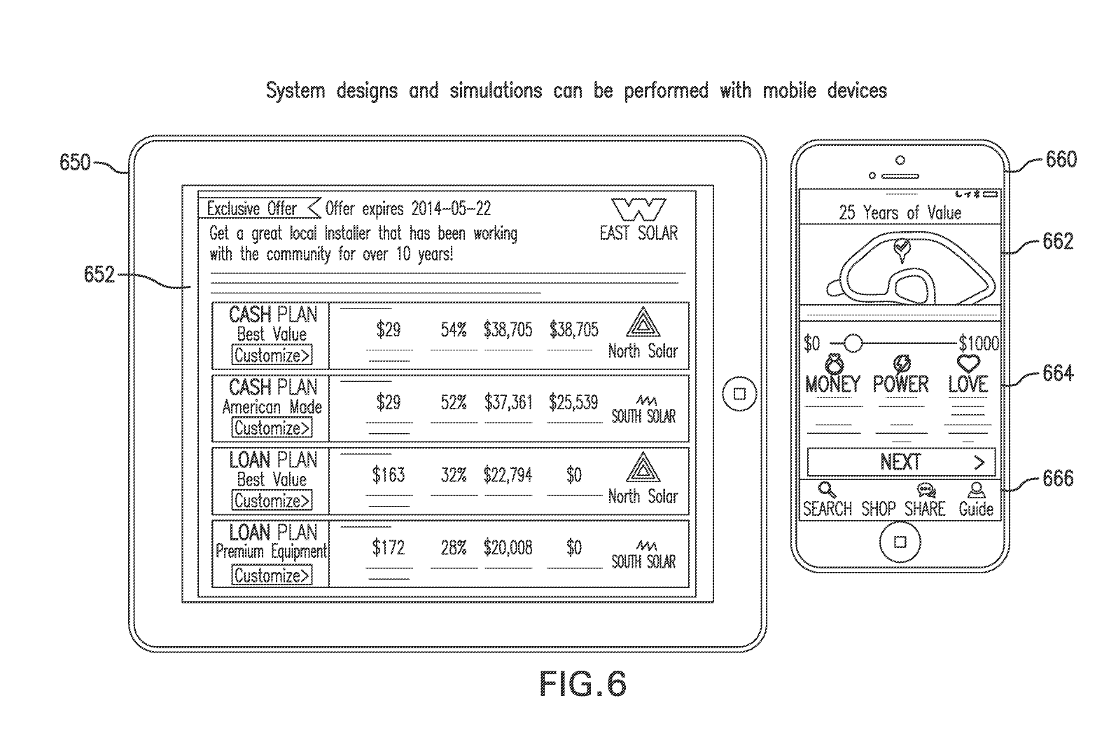

FIG. 6 is a diagram that illustrates two example displays of information on a tablet device 650 and mobile phone device 660 based on output from an online energy marketplace, according to an embodiment. Display 652 in device 650 shows different financing options (e.g., a cash plan and a loan plan) provided by two different installers. Customize buttons are provided to allow a user to further input data to customize a particular plan through the online solar marketplace.

Display 662 in device 660 three panels or areas 662, 664, and 666. Panel 662 provides a display area for a map display of a particular property being simulated in the online solar marketplace for a solar installation offering. Panel 664 includes display simulation results in several ways according to a feature. First a current average electrical bill value is displayed alongside a slider for enabling a user to change the value over a range of values by moving the slider setting. Three areas for displaying data relating to Money (value of energy, total incentives), Power (system size, electric usage offset), and Love (carbon reduction equivalent in CO2 lbs and miles driven in a car). A navigation bar 666 allows further navigation to a different window.

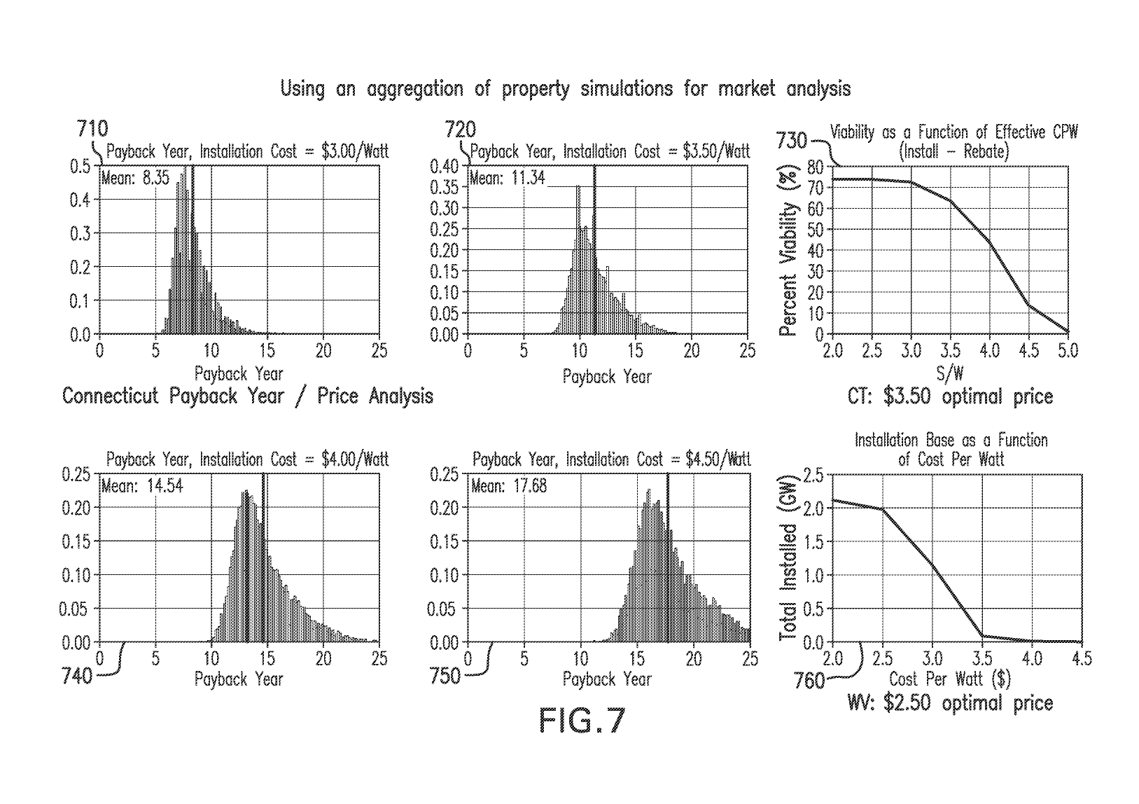

FIG. 7 is a diagram illustrating market analysis based on market simulations of particular geopolitical regions, according to an embodiment. In the examples here the top row shows three graphs of simulation results for a region in Connecticut (710, 720, 730), while the bottom row of graphs shows three graphs of simulation results for a region in West Virginia (740, 750, 760). Graph 710 shows a bar graph plot of the payback years for a normalized number of property simulations. Graph 710 shows a mean payback year of 8.35 years (from time of installation to time when all installation costs equal energy cost savings) when installation cost is $3.00/watt). Graph 720 shows the plot of the payback years for the same normalized number of property simulations of graph 710 when the cost installation is $3.50/Watt which lengthens the mean payback year to 11.34 years in the Connecticut region. Graph 730 is a line graph plot that shows the percent of properties viable for a solar installation as a function of effective cost per watt (CPW), which accounts for total installed costs less any rebates. In this example, the viability is over 60% for costs per Watt more than $3.50, which indicates one optimal price may be $3.50/Watt.

Graph 740 shows a bar graph plot of the payback years for a normalized number of property simulations in a West Virginia (WV) region. Graph 740 shows a mean payback year of 14.54 years (from time of installation to time when all installation costs equal energy cost savings) when installation cost is $4.00/watt). Graph 750 shows the plot of the payback years for the same normalized number of property simulations of graph 740 when the cost installation is $4.50/Watt which lengthens the mean payback year to 17.68 years in the WV region. Graph 760 is a line graph plot that shows the total amount of gigawatts likely to be viably installed for the region properties as a function of cost per watt (CPW) which accounts for installation costs. In this example, the installed amount drops at a greater rate for costs per Watt over $2.50, which indicates one optimal price may be $2.50/Watt.

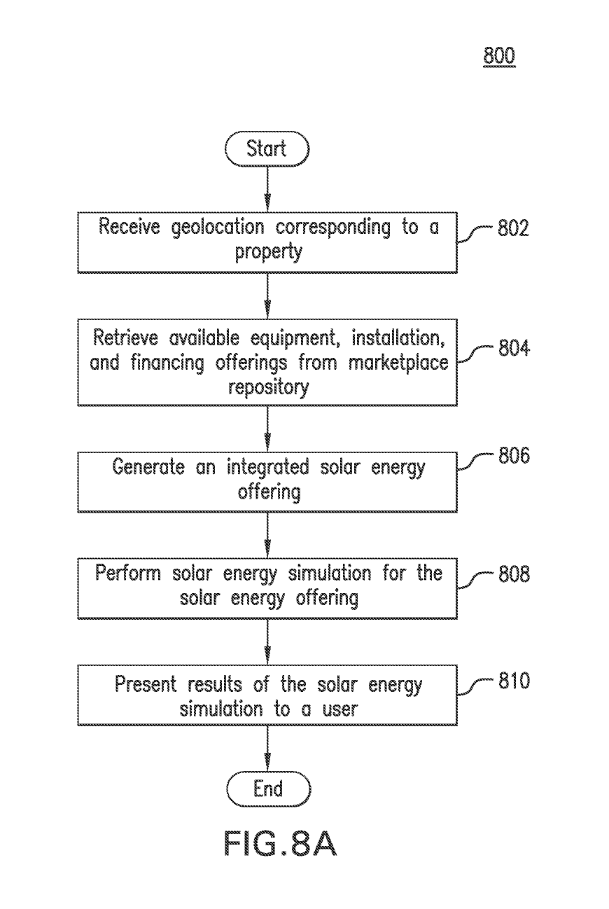

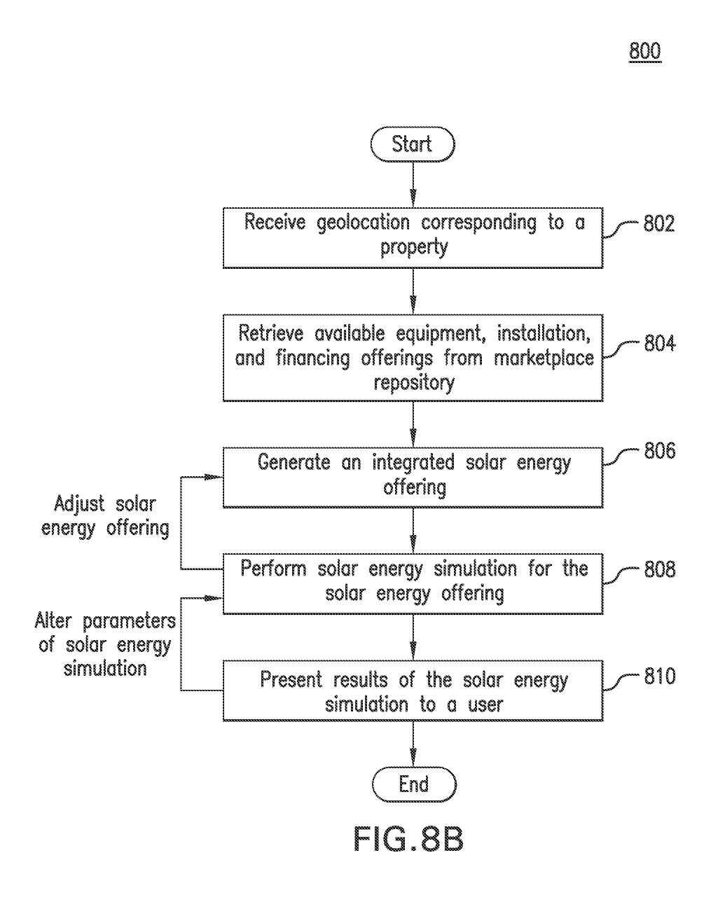

FIGS. 8A and 8B are example methods for presenting a solar energy offering to a user of a solar energy marketplace, according to an embodiment. Method 800 begins at stage 802 by receiving a geolocation corresponding to a property. In an embodiment, the geolocation may be entered manually by a user of the marketplace, for example, in the form of a postal address. In various embodiments, the geolocation may be determined automatically via a user device, for example, by location data taken from a mobile device.

At stage 804, available equipment, installation, and financing offerings may be retrieved from a marketplace repository, such as marketplace repository 1440 of FIG. 14. In an embodiment, marketplace repository may store a plurality of service and equipment offerings from one or more equipment providers, installation providers, and financing providers, as described with respect to FIGS. 1 and 2. Available offerings may be determined by the received geolocation. For example, an installation provider may only service a particular geographic region, or certain equipment promotions may only apply to specific properties. In an embodiment, an interface may be provided interface for providers to enter and update service and equipment offerings, for example via a graphical user interface or application programming interface (API).

At stage 806, an integrated solar energy offering for the property is generated based on the retrieved equipment, installation, and financing offerings. This offering may be assembled taking into account characteristics of the property and authorized combinations of equipment, installation, and financing, as described with respect to FIG. 1. The offering may be priced according to a pricing model, such as described above with respect to FIG. 2. In an embodiment, the cost of the offering may be normalized based on the capacity/size of the solar array specified in the solar energy offering.

At stage 808, a solar energy simulation may be performed for the solar energy offering in order to estimate solar energy production over a given time period. For example, it may be useful to estimate solar energy production during the next 25 years, as this time period may represent the expected life of solar modules in the solar array. In an embodiment, multiple simulations may be performed by altering one or more parameters of the simulation, as described with respect to FIGS. 3 and 4. For example, atmospheric conditions or physical obstructions (e.g., trees and other vegetation), may be modified in each simulation. The results of each simulation may then be aggregated or averaged in order to improve energy production estimates. In an embodiment, energy production analysis may be performed based on the energy production estimates to determine a levelized cost of energy for solar and overall energy costs, as described with respect to FIG. 3.

At stage 810, the solar energy offering and simulation results, such as energy production estimates, may be presented to the user. In an embodiment, the solar energy offering may be compared to conventional electricity options so that the user may directly compare the value of the solar energy offering. In an embodiment, the presentation of results may be constructed at a server, such as server 1410 of FIG. 14, and rendered at a client, such as client 1402, of FIG. 14.

In an embodiment, the solar energy offering may be modified, or new offerings may be created, based on results of additional simulations and energy production analysis. As illustrated in FIG. 8B, parameters for the solar energy simulation may be altered and a second solar energy simulation may be performed based on the altered parameters. For example, parameters such as, but not limited to, tilt and azimuth of solar panels, size of installations, number and efficiency of panels, building code requirements, setbacks, buildable areas, shading from vegetation (for example, a user may decide to cut down a tree or increase foliage), energy usage (e.g., load profile), utility rates, energy inflation, available or applicable incentives, lease terms, down payment, term of loan, financing charges, and installed cost may be altered for a solar energy simulation, as described with respect to FIG. 4. In various embodiments, alterations may be input by a user or determined automatically. The solar energy offering may then be adjusted based on the results of the second solar energy simulation. For example, results and analysis of the second energy simulation may indicate that optimal energy production and costs may be achieved by increasing the number of solar modules in the solar energy offering. In this manner, the offerings are intended to reflect the best value and performance based on multiple scenarios. The modified solar energy offering and simulation results may then be presented to the user.

In an embodiment, broad market simulations may be generated by running simulations on a plurality of properties within a particular geographic or geopolitical region and may be used in a number of ways. For example, in an embodiment, the online solar marketplace may enable users to rank and sort properties within a region, or rank and sort regions, according to solar energy capacity. These rankings may be adjusted based on determined propensities to adopt solar energy in order to rank and sort property owners and populations according to overall solar market opportunity. In an embodiment, the propensity to adopt solar may be determined by, for example, credit scores, consumer behavior, consumer demographics, political views, and real estate values. In an embodiment, broad market simulations may also be run on specific properties spread across regions based on other factors or shared characteristics, for example, all properties with gable roof types.

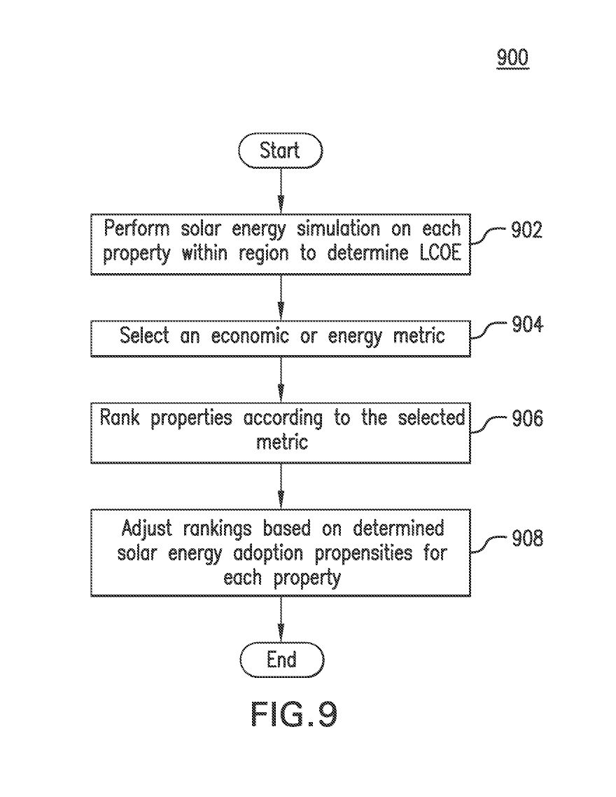

FIG. 9 illustrates an example method for ranking, sorting and analyzing individual properties within a geographic or geopolitical region, according to an embodiment. Method 900 begins at stage 902 by performing a solar energy simulation on each property within the region to determine the levelized cost of energy (LCOE) for a period of time (e.g., 25 years). At stage 904, an economic or energy metric may be selected to perform the ranking of the individual properties. An example metric may be based on solar energy production potential at a particular property using factors such as shadow, slope, and orientation of available roof facets, as well as total buildable area. Another example metric may be based on economic models used to estimate an internal rate of return (IRR), net present value, and total savings for a potential solar energy installation at the property. In this example, IRR, net present value, and savings may be estimated by comparing the determined LCOE to the cost of conventional electricity.

At stage 906, the individual properties within the region may be ranked according to the selected metric. At stage 908, the rankings may be adjusted based on determined propensities to adopt solar energy at each property in order to rank properties according to highest solar energy conversion potential.

In addition to ranking and analyzing individual properties within a region, geopolitical regions, such as zip codes, municipalities, counties, states, and countries, may be analyzed to determine solar capacity and solar adoption propensity through a sampling or census of individual properties.

In an embodiment, the LCOE may be first characterized for each property within the sample or census based on atmospherics, shadow, slope and orientation. The cost of solar may then be characterized for each property based on conventional electricity rates, load profiles, utility inflation rates and available incentives, compared with LCOE in the region. A demonstrative solar site may be placed in the region, the specifics of which (e.g., size) may be based upon common or notional solar buyer behavior. In an embodiment, economic metrics may be determined and selected through economic modeling performed on each property. Economic metrics may include, but are not limited to, specific site performance measures (e.g., IRR), or measures which aggregate for all sites in a region, for example but not limited to, system savings multiplied by the number of potential residential or business sites. Regions may be ranked and sorted based upon the selected metric, such as an aggregate IRR for each property within the sample or census. Elements of the simulations on individual properties may be modified to determine the total addressable market under various scenarios. For example, simulations may be run with different incentives, utility rates, and/or financing options.

### Example Sponsorship Role in Solar Energy Marketplace

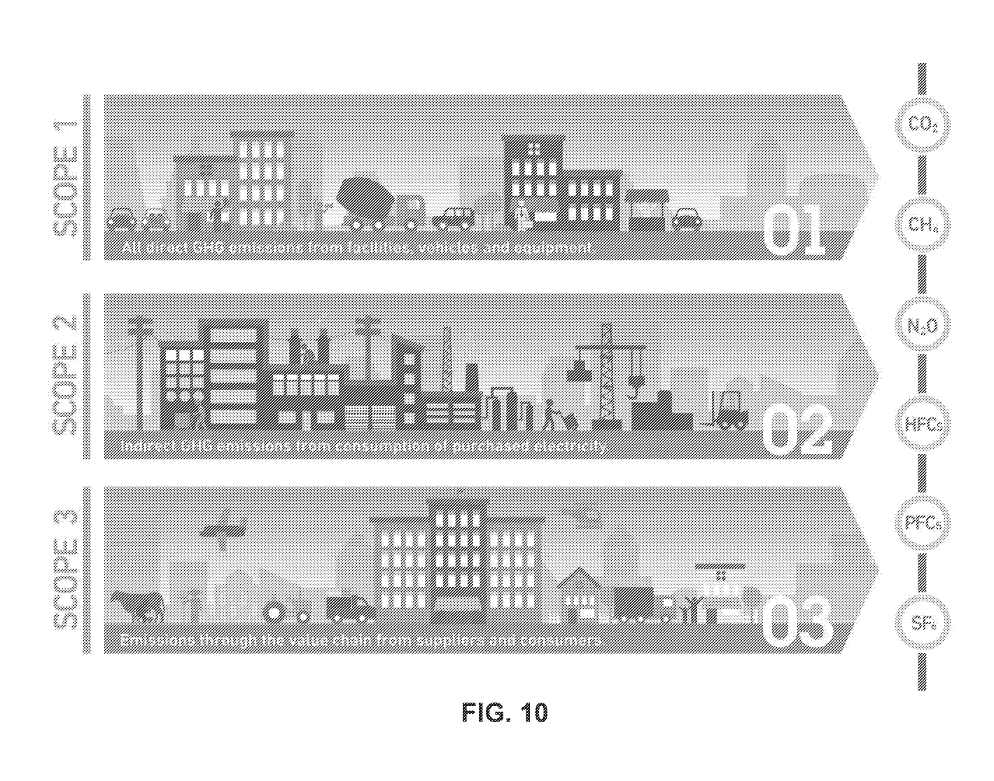

FIG. 10 is a diagram illustrating scope 1, scope 2, and scope 3 greenhouse gas (GHG) emissions categories, according to an embodiment. Many corporations publish sustainability plans with details on GHG emissions related to the facilities and vehicles owned and operated by the company (Scope 1), emissions produced by the power plants that generate the electricity consumed by direct company operations and facilities (Scope 2) and indirect emissions related to the supply chain, distribution and travel (Scope 3). At the end of each reporting period, progress toward the reduction of emissions may be reported for each scope.

Sustainability teams often find that meeting total emissions reduction goals is very difficult. As the business itself grows, the expanding operations increase emissions. Scope 3 emissions are a particularly intractable problem. For example, hotels need to encourage, not reduce, guest travel, businesses require employees to commute to the office and travel for meetings and conferences, and ecommerce companies need to ship products around the world.

When sustainability teams cannot reduce emissions, they will sometimes offset emissions through the purchase of VCUs (Verified Carbon Units, also referred to as offsets) or RECs (Renewable Energy Certificates). It is commonly accepted that VCUs and RECs are only a last resort, and should only be applied to emissions that cannot be reduced. The solar energy marketplace provides an opportunity for corporations to directly contribute to the generation of carbon reductions rather than simply purchasing existing offsets.

In an embodiment, the solar energy marketplace partners with sponsors to provide promotions to customers to encourage solar energy adoption. Sponsors are typically corporations concerned with reducing their carbon emissions and achieving sustainability goals. One of skill in the art will appreciate that sponsors need not be corporations and may be any entity. For example, a sponsor may be a state municipality operating CO₂e reduction initiatives. However, corporations are used throughout the present disclosure by way of example.

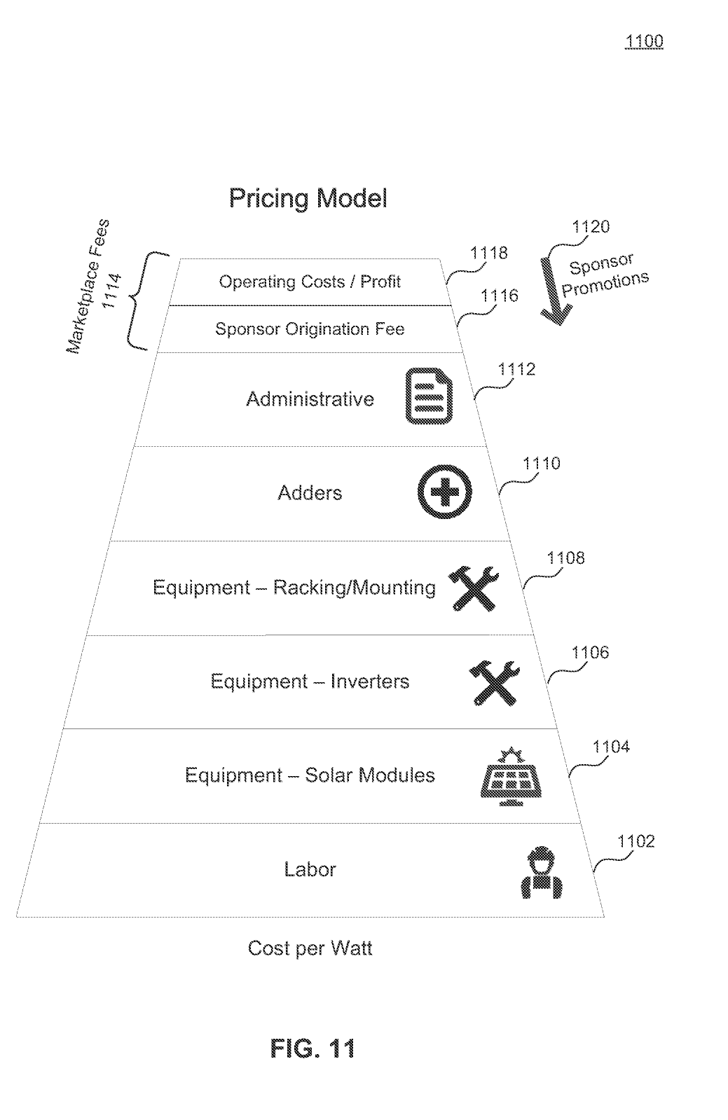

FIG. 11 is a diagram illustrating an example pricing model for a solar energy offering incorporating marketplace sponsors, according to an embodiment. As described previously with respect to FIG. 2, a solar energy offering may include labor costs, equipment costs, adder costs, administrative costs, and marketplace fees. The total cost of the offering may be normalized by cost per Watt in order to directly compare options involving systems of different size. By allowing multiple providers to participate in the solar energy offering, prices reflect market rates due to pricing transparency among providers. Without such a marketplace, price discrimination may occur due to a lack of consumer knowledge.

The marketplace may earn fees for facilitating a solar installation, as shown at 1114. In an embodiment, a portion of marketplace fees 1114 may be used for operating costs and profit, as shown at 1118, and if applicable, a portion may be awarded to a sponsor as a referral or origination fee, as shown at 1116.

Sponsors may be motivated to partner with the solar marketplace in order to generate additional revenue, provide solar energy discounts to employees, and offset carbon emissions produced by the sponsor. In order to achieve these goals, sponsors are encouraged to enroll customers, employees, and suppliers to install solar energy systems on their property.

According to an embodiment, a sponsor may provide a promotion 1120 to further motivate installation of solar energy systems. These promotions are intended to encourage solar energy adoption and benefit property owners by potentially reducing the cost of solar energy, as illustrated in FIG. 11. In an embodiment, promotions may take the form of services that market solar to individuals and refer them to the marketplace, or promotions may be in the form of a discounted price for a solar energy offering. In a non-limiting example, a sponsor may offer a discount of $0.20 per Watt, reducing the overall cost of a solar energy offering. In a further embodiment, sponsor promotions may not only apply to customers, employees, and suppliers of the sponsor, but other users of the marketplace as well. For example, the sponsor may provide promotions to property owners in a particular geographic region, or in general to all property owners. In an embodiment, sponsors may accrue origination and referral fees for each originated solar installation based on sponsor promotions. These fees may be collected as revenue, used to provide discounts to employees, or used toward new or existing promotions. In an embodiment, energy production resulting from a sponsored solar energy installation may be registered as verified CO₂e emissions reductions (e.g., VCUs, SRECs, etc.), which may be transferred to the sponsor to offset other carbon emissions. A sponsor may choose to receive these offsets rather than accruing monetary fees, which is discussed further below.

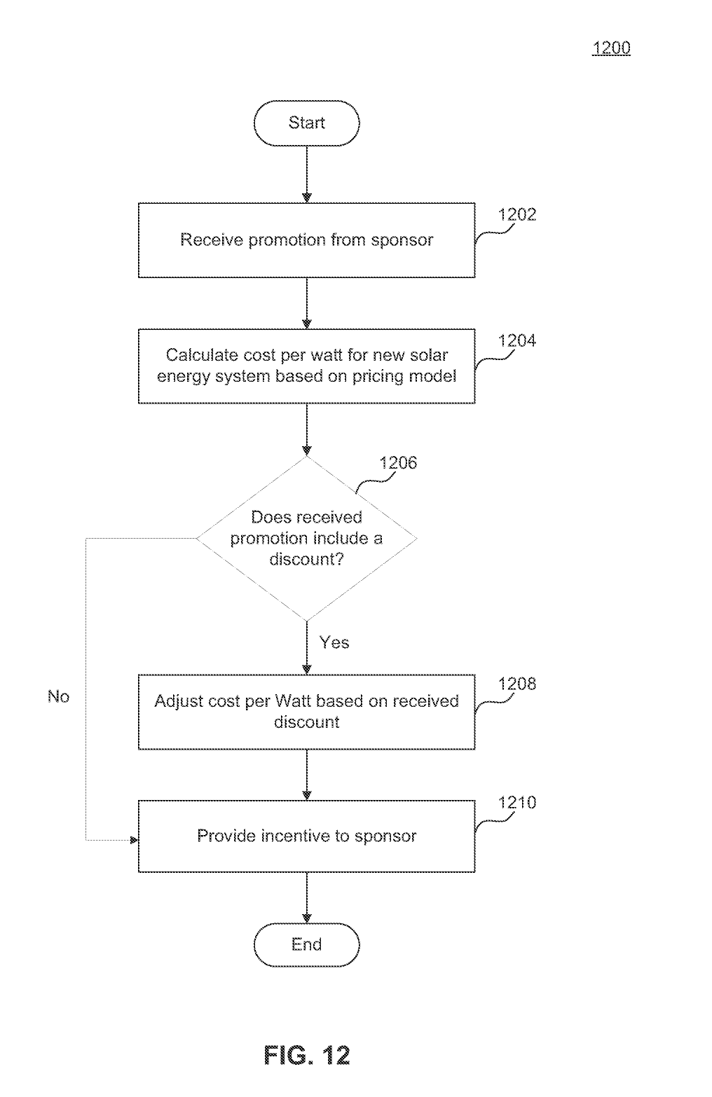

FIG. 12 is an example method 1200 for calculating the cost of a solar energy offering that includes a sponsor promotion, according to an embodiment. Method 1200 begins at stage 1202 by receiving a promotion from a sponsor. In various embodiments, sponsor promotions may include discounts, upfront or delayed rebates, periodic payments based on solar energy production (e.g., $0.50 per kWh of solar energy produced), or loyalty points. In an embodiment, loyalty points may be redeemed for cash or other benefits in the future.

In an embodiment, a promotion may be fixed or variable. A variable discount, for instance, may be applied based on one or more factors involved in individual property or broad market simulations. For example, a property or region with higher insolation levels or higher traditional utility rates may be given a smaller discount than a property or region with lower insolation levels and more affordable traditional utility rates. In this manner, a property owner that will benefit more from a solar energy installation may receive a smaller incentive to adopt solar. Alternatively, sponsors may choose to provide properties or regions that have higher energy generation potential with larger discounts. In this manner, property owners that are able to contribute more to overall carbon reduction initiatives may receive a greater incentive to adopt solar.

At stage 1204, the total cost of the solar energy offering is calculated, for example according to the pricing model of FIG. 11. The total cost may be normalized to reflect the cost per Watt of the solar energy system. At stage 1206, it is determined whether the received promotion includes a discount. If so, the method proceeds to stage 1208, where the calculated cost is adjusted based on the received promotion discount. For example, if the solar energy offering is calculated to cost $1.62 per Watt and a sponsor discount of $0.10 is applied, the cost is adjusted to $1.52 per Watt. If the sponsor promotion does not include a discount, the method proceeds directly to stage 1210.

At stage 1210, once a solar energy system is installed, an incentive may be provided to the sponsor. For example, an origination or referral fee that accrues based on the solar energy installation may be collected by the sponsor from the marketplace. This fee may, for example, be provided as cash revenue to the sponsor, used to provide solar energy discounts to employees, or used to invest in existing or new promotions. A sponsor may also choose to receive registered CO₂e emissions reductions rather than or in addition to accruing monetary fees, which may then be transferred or used to offset the sponsor's carbon emissions.

As previously discussed, a sponsor may be concerned with offsetting scope 1, scope 2, and scope 3 GHG emissions, rather than or in addition to gaining origination and referral fees. In an embodiment, the marketplace may monitor and calculate the amount of CO₂e reduction attributed to the installed solar energy system. Energy generated by the system may be registered with a carbon offset registry as verified CO₂e emissions reductions (referred to generically herein as carbon credits), for example in the form of carbon credits or renewable energy certificates, which may be aggregated by the marketplace. For example, every 1 MWh of energy produced by the system may be registered as a carbon credit. By receiving a promotional discount from a sponsor, the owner of the solar energy system may agree to transfer these generated carbon credits to a sponsor. The sponsor is then free to apply the carbon credits to offset scope 1, 2, and 3 emissions. Carbon credits may take the form of, for example, verified carbon units (VCUs) or solar renewable energy credits (SRECs). SRECs may be particularly desirable because of generally higher market prices and strong credibility.

The marketplace allows a sponsor to avoid simply purchasing carbon offsets, enabling a sponsor to directly contribute to the generation of carbon credits. In instances where sponsors effect solar energy installations by employees, suppliers, or customers, the generated carbon credits may be classified as insets. Insets are becoming widely preferred over the simple purchase of carbon offsets because CO₂e reduction can be directly attributable to the operations of the sponsor. This allows sponsors to achieve sustainability goals without resorting to the purchase of generic carbon offsets.

Insets and other direct carbon reduction contributions may allow sponsors to achieve green certifications, such as the Gold Standard® certification. Adherence to certification requirements ensure that sponsor programs actually reduce CO₂ emissions, and provide benefits to society, rather than generically paying to offset the sponsor's carbon footprint. Certifications such as these further lend to the reputation and credibility of a sponsor.

Any authorized registry may be used to register produced solar energy by the solar energy system. For example, the Verified Carbon Standard (VCS) registry may be used to register produced solar energy, and the marketplace may aggregate VCU certificates to provide to the sponsor. In an embodiment, a registry may be integrated directly into the marketplace. In this manner, the marketplace may generate carbon offset certificates from energy produced by the solar energy system, aggregate the certificates, and provide them to the sponsor. This reduces registration costs by obviating the need to register produced solar energy with third-party systems.

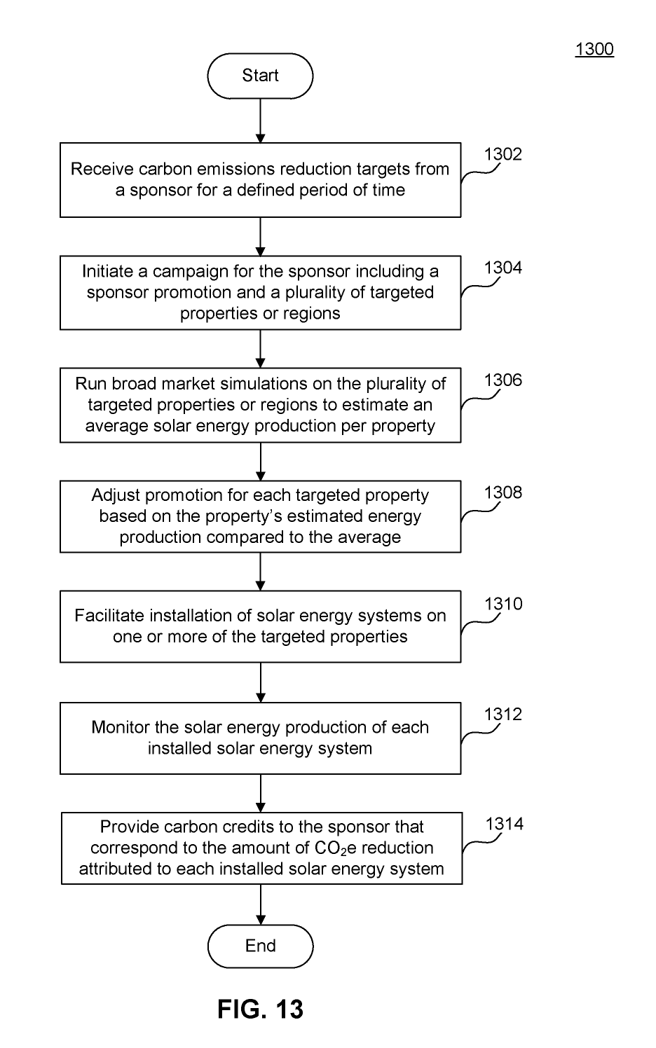

FIG. 13 is an example method 1300 for facilitating generation of carbon credits to offset a sponsor's carbon emissions, according to an embodiment. Method 1300 begins at stage 1302 by receiving one or more carbon emissions reduction targets from a sponsor for a particular time period (e.g., annual targets). In various embodiments, reduction targets may be provided as carbon emissions estimates for the sponsor (e.g., annual corporate scope 1, 2, and 3 emissions), or as emission reduction goals.

At stage 1304, a sponsor campaign may be initiated for the sponsor that includes a sponsor promotion and a plurality of targeted properties or regions. Sponsor campaigns may be used to monitor the efficacy of sponsor promotions in achieving the sponsor's carbon emissions reduction goals. This enables a sponsor to make informed decisions when adding, modifying, or removing promotions during the course of a campaign.

At stage 1306, one or more broad market simulations may be run on the plurality of targeted properties or regions to estimate an average solar energy production. In an embodiment, simulations may be run on a general sampling of the targeted properties and/or regions. Alternatively, the sponsor may specify particular properties, or identify particular properties based on shared characteristics, to include in the broad market simulations. Simulations on individual properties involved in the broad market simulations may be performed as described with respect to FIGS. 3 and 4 in order to estimate solar energy production of each property. An average of these estimates may then be taken.

In an embodiment, the broad market simulations and received carbon emissions reduction targets may be used to suggest effective promotions to the sponsor and evaluate existing promotions. In an embodiment, the estimated average solar energy production may be converted to an amount of CO₂e reduction, as described with respect to FIG. 4. For example, a property that produces 100,000 kWh of energy over 10 years may generate approximately 100 metric tons of CO₂e reduction. The emissions targets of the sponsor may be divided by this number, providing an approximate number of solar energy installations that the sponsor needs to originate in order to meet sustainability goals. The approximate number of solar installations may also be multiplied by the average solar energy output per property in order to provide an estimated total amount of solar energy output. To achieve sustainability goals, this amount of energy would need to be produced as a result of sponsor promotions. These estimated values may be provided directly to the sponsor to aid in defining a promotion to include in the campaign. These estimated values may also be used to monitor goal progress.

At stage 1308, the sponsor promotion may be adjusted for each targeted property based on the property's estimated energy production compared to the average solar energy production across the targeted properties. For example, a sponsor promotion may include a general discount of $0.20 per watt for solar installations. This discount may be increased for individual properties with above average solar energy production potential. In this manner, property owners that are able to contribute more to the sponsor's carbon emissions reduction targets may receive a larger discount relative to other properties within the region for which the promotion applies, and thus may have a greater incentive to adopt solar.

At stage 1310, installation of solar energy systems on one or more of the targeted properties may be facilitated. In an embodiment, integrated solar energy offerings may be generated and priced by a solar marketplace, as described with respect to FIG. 11. This enables individual property owners to receive market rates for solar energy systems while receiving a promotional discount or other incentive from the sponsor.

At stage 1312, the solar energy production of each installed solar energy system may be monitored to determine actual solar energy produced by the installed systems. In order to track and monitor solar energy production, the marketplace may be connected to installed solar energy systems. In an embodiment, solar inverters within a solar energy system may include built in energy monitoring hardware and/or software components to track energy produced by installed solar panels and converted by the solar inverters. The solar energy system may further include a data connection to periodically transmit energy production data to the marketplace.

In an embodiment, one or more electricity meters may be used in addition to or as an alternative to monitoring components built into solar inverters. These electricity meters may track net generation of electricity generated by monitoring electricity flow from the solar energy system (e.g., the solar inverters) to the property or electrical grid. The energy production values tracked by the electricity meters may also periodically be transmitted to the marketplace. In an embodiment, measurements taken by electricity meters may be compared to energy production recorded by solar energy inverters to ensure accuracy of energy production calculations. Monitored energy production values received by the marketplace may be used to calculate CO₂e reduction attributable to the installed solar energy system.

Finally, at stage 1314, carbon credits may be provided to the sponsor that correspond to the amount of carbon dioxide equivalent (CO₂e) reduction attributed to each installed solar energy system. In an embodiment, energy generated by installed solar energy systems may be registered with a carbon offset registry as verified CO₂e emissions reductions, which may be issued in the form of carbon credits. These carbon credits may then be aggregated and provided to the sponsor. For example, every 1 MWh of energy produce by an installed system may correspond to one carbon credit. By receiving a promotional discount from a sponsor, the owner of the solar energy system may agree to transfer these generated carbon credits to a sponsor. The sponsor is then free to apply the carbon credits to offset scope 1, 2, and 3 emissions, contributing to the sponsor's carbon emissions reduction targets. In an embodiment, an indication of the provided carbon credits compared to the sponsor's carbon emissions reduction targets may be tracked and viewable by the sponsor.

In an embodiment, stage 1314 first verifies that energy produced by a solar energy system can be registered as verified CO₂e emissions reductions. For example, certain regions may automatically allocate emissions reduction credits to a utility company, rather than to the property owner where the solar energy system is installed. In this case, a sponsor may choose to receive other incentives as a result of energy produced by the solar energy system, such as cash or other redeemable credits.

FIG. 14 is a diagram illustrating an example system for providing a solar energy marketplace, according to an embodiment. System 1400 includes a client 1402 and a server 1410 connected by one or more networks 1404, such as the Internet. Server 1410 is also coupled to a geomatics data repository 1430 and marketplace repository 1440.

Client 1402 may, for example, include a web browser that enables a user to interact with a solar energy marketplace. The web browser may respond to user input by sending a hypertext transfer protocol (HTTP) request to server 1410 via network 1404. In another example, the user may interface with client 1402 through a native application instead of a web browser, such that the native application communicates with serve 1410. Client 1402 may be any type of computing device, such as and without limitation, a PC, laptop, or mobile device.

In an embodiment, server 1410 includes data collection module 1412, simulation module 1414, pricing module 1416, incentives module 1418, query module 1420, update module 1422, interface module 1424, and monitoring module 1426. Data collection module 1412 may construct a property model as described with respect to FIG. 3 in order to collect various data about the property. Such data may include, but is not limited to latitude and atmospheric conditions, roof shadows, slope and orientation, buildable area, setbacks, and obstructions. This data may be stored in geomatics repository 1430 for use by simulation module 1414.

In an embodiment, simulation module 1414 may run solar energy simulations and perform energy production analysis as described with respect to FIGS. 3 and 4. Results from a simulation and energy production analysis may be stored in marketplace repository 1440. Simulation module 1414 may also aggregate simulation results from a plurality of simulations and facilitate collaboration of users around a simulation.

In an embodiment, pricing module 1416 may enable pricing information to be entered into the marketplace by a plurality of solar energy providers. In a further embodiment, the marketplace may implement a bidding system for solar energy offerings, and prices may differ between offerings based on entered bids. Pricing module 1416 may also calculate total cost and normalized cost per Watt for a solar energy offering, for example as described with respect to FIGS. 2 and 11. In an embodiment, entered prices and calculated costs may be stored in marketplace repository 1440.

In an embodiment, incentives module 1418 may enable sponsors to provide promotions in the marketplace and collect benefits based on those promotions, as described with respect to FIGS. 11-13. Incentives module 1418 may also apply discounts, promotions, rebates, federal incentives, and/or local incentives to installation and energy costs of a solar energy offering. In a further embodiment, pricing module 1416 may use information from incentives module 1418 to adjust calculated costs for a solar energy offering. In various embodiments, incentives module 1418 may retrieve promotions, rebates, federal incentives, and/or local incentives from a third-party via a network.

In an embodiment, monitoring module 1426 my track and monitor actual solar energy production from installed solar energy systems, as described with respect to FIG. 13. Monitoring module 1426 may be used in conjunction with monitoring hardware and/or software components built into or coupled to installed solar energy systems to ensure accurate solar energy production measurements are received.

In an embodiment, server 1410 is coupled to carbon offset registry 1450 via network 1404. Carbon offset registry 1450 enables incentives module 1418 to register solar energy produced by a solar energy system as carbon credits, as described with respect to FIG. 12. These credits may be used by a sponsor to achieve CO₂e reduction goals. In various embodiments, carbon offset registry 1450 may be connected to server 1410 via a separate local area network (LAN) or be part of server 1410.

In an embodiment, query module 1420 may retrieve data from geomatics repository 1430 for use by simulation module 1414 in running solar energy simulations. Query module 1420 may also retrieve data from marketplace repository upon request by any of the modules of serve 1410. In an embodiment, update module 1422 may be responsible for writing data to geomatics repository 1430 and marketplace repository 1440. In an embodiment, interface module 1424 may present marketplace data to client 1402 via network 1404.

Geomatics repository 1430 may store data related to a plurality of properties collected by data collection module 1412. Geomatics repository 1430 may be any type of structured data store, including a relational or document-oriented database, such as an SQL-compatible database.

Geomatics repository 1430 may store data in a plurality of different data tables 1434A, B, etc. To improve performance of database queries and updates, geomatics repository 1430 may also include an index table 1432. In an embodiment, update module 1422 queries index table 1432 to assist with data insertions and updates, and query module 1420 queries index table 1432 to assist with data retrieval. In an embodiment, the index table may point to entries in data tables 1434, which include complete data records. Or, in an embodiment where the database is de-normalized, the index table may itself include individual data records in part or in full. In this way, index table 1432 may be used to improve performance of database queries and updates.

Marketplace repository 1430 may store various marketplace data, such as but not limited to, simulation data, pricing data, user data, incentives data, and performance data. Marketplace repository 1430 may be any type of structured data store, including a relational or document-oriented database, such as an SQL-compatible database.

Marketplace repository 1430 may store data in a plurality of different data tables 1434A, B, etc. To improve performance of database queries and updates, marketplace repository 1430 may also include an index table 1432. In an embodiment, update module 1422 queries index table 1432 to assist with data insertions and updates, and query module 1420 queries index table 1432 to assist with data retrieval. In an embodiment, the index table may point to entries in data tables 1434, which include complete data records. Or, in an embodiment where the database is de-normalized, the index table may itself include individual data records in part or in full. In this way, index table 1432 may be used to improve performance of database queries and updates.

In an embodiment, data in geomatics repository 1430 and marketplace repository 1440 may be accessed via an application programming interface (API). In this manner, the API may allow third party applications to, for example, analyze simulation data and monitor performance of solar energy systems.

Server 1410 and its example constituent modules 1412-1424 in FIG. 14 may be implemented on the same or different computing systems having server functionality, in hardware, software, or any combination thereof. Such computing systems may include, but are not limited to, a personal computer, a mobile device such as a mobile phone, workstation, embedded system, game console, television, set-top box, or any other computing device. Further, a computing system may include, but is not limited to, a device having a processor and memory, including a nontransitory memory, for executing and storing instructions. The memory may tangibly embody the data and program instructions. Software may include one or more applications and an operating system. Hardware may include, but is not limited to, a processor, memory, and graphical user interface display. The computing system may also have multiple processors and multiple shared or separate memory components. For example, the computing system may be a part of or the entirety of a clustered computing environment or server farm. Geomatics repository 1430 and marketplace repository 1440 may be implemented on the same or different computing systems. In an embodiment, the repositories may be part of the same or separate database instances.

The automated systems and methods described above, for example in FIGS. 13 and 14, lead to increased solar adoption through use of sponsorship promotions, resulting in a reduction of GHG emissions and a physical transformation of atmospheric conditions. In this manner, the described sponsorship roles create positive externalities by encouraging and facilitating this use of renewable solar energy, in effect changing both corporate management practices and consumer behavior to wrought physical transformation of atmospheric conditions using computer-implemented technologies.

### Example Computer System

FIG. 15 is an example computing system useful for implementing various embodiments. Various embodiments can be implemented, for example, using one or more well-known computer systems, such as computer system 1500. Computer system 1500 can be any well-known computer capable of performing the functions described herein, such as computers available from International Business Machines, Apple, Sun, HP, Dell, Sony, Toshiba, etc.

Computer system 1500 includes one or more processors (also called central processing units, or CPUs), such as a processor 1504. Processor 1504 may be connected to a communication infrastructure or bus 1506.

One or more processors 1504 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 1500 also includes user input/output device(s) 1503, such as monitors, keyboards, pointing devices, etc., which communicate with communication infrastructure 1506 through user input/output interface(s) 1502.

Computer system 1500 also includes a main or primary memory 1508, such as random access memory (RAM). Main memory 1508 may include one or more levels of cache. Main memory 1508 has stored therein control logic (i.e., computer software) and/or data.

Computer system 1500 may also include one or more secondary storage devices or memory 1510. Secondary memory 1510 may include, for example, a hard disk drive 1512 and/or a removable storage device or drive 1514. Removable storage drive 1514 may be a floppy disk drive, a magnetic tape drive, a compact disk drive, an optical storage device, tape backup device, and/or any other storage device/drive.

Removable storage drive 1514 may interact with a removable storage unit 1518. Removable storage unit 1518 includes a computer usable or readable storage device having stored thereon computer software (control logic) and/or data. Removable storage unit 1518 may be a floppy disk, magnetic tape, compact disk, DVD, optical storage disk, and/or any other computer data storage device. Removable storage drive 1514 reads from and/or writes to removable storage unit 1518 in a well-known manner.

According to an exemplary embodiment, secondary memory 1510 may include other means, instrumentalities or other approaches for allowing computer programs and/or other instructions and/or data to be accessed by computer system 1500. Such means, instrumentalities or other approaches may include, for example, a removable storage unit 1522 and an interface 1520. Examples of the removable storage unit 1522 and the interface 1520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1500 may further include a communication or network interface 1524. Communication interface 1524 enables computer system 1500 to communicate and interact with any combination of remote devices, remote networks, remote entities, etc. (individually and collectively referenced by reference number 1528). For example, communication interface 1524 may allow computer system 1500 to communicate with remote devices 1528 over communications path 1526, which may be wired and/or wireless, and which may include any combination of LANs, WANs, the Internet, etc. Control logic and/or data may be transmitted to and from computer system 1500 via communication path 1526.

In an embodiment, a tangible apparatus or article of manufacture comprising a tangible computer useable or readable medium having control logic (software) stored thereon is also referred to herein as a computer program product or program storage device. This includes, but is not limited to, computer system 1500, main memory 1508, secondary memory 1510, and removable storage units 1518 and 1522, as well as tangible articles of manufacture embodying any combination of the foregoing. Such control logic, when executed by one or more data processing devices (such as computer system 1500), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 15. In particular, embodiments may operate with software, hardware, and/or operating system implementations other than those described herein.

### Example User Interface

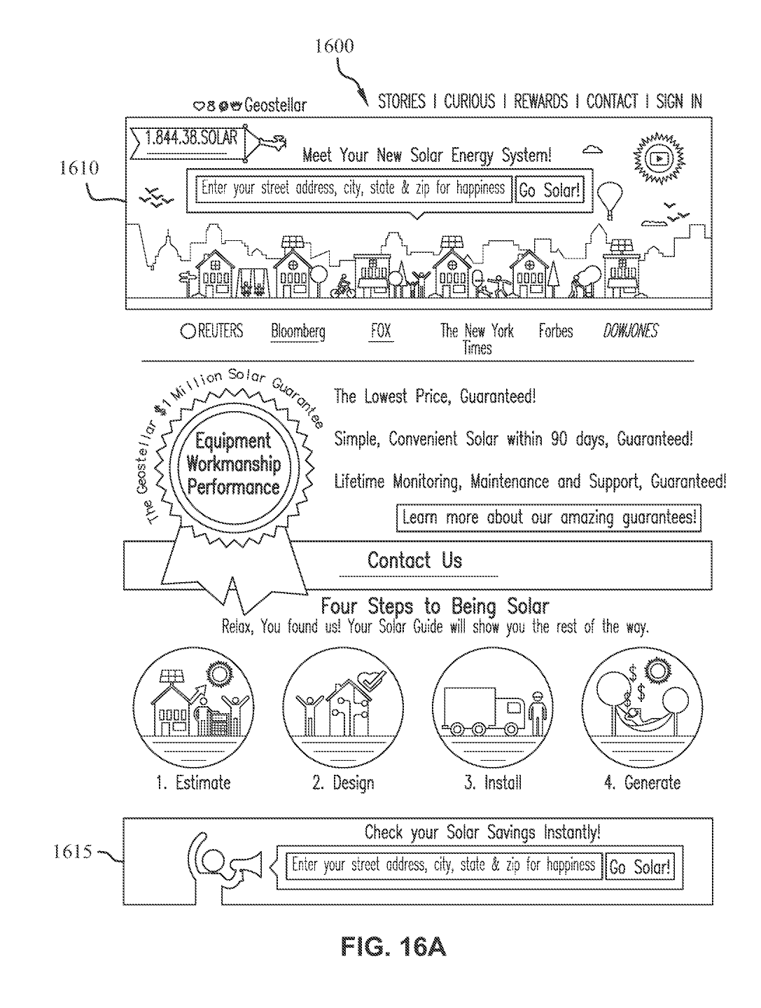

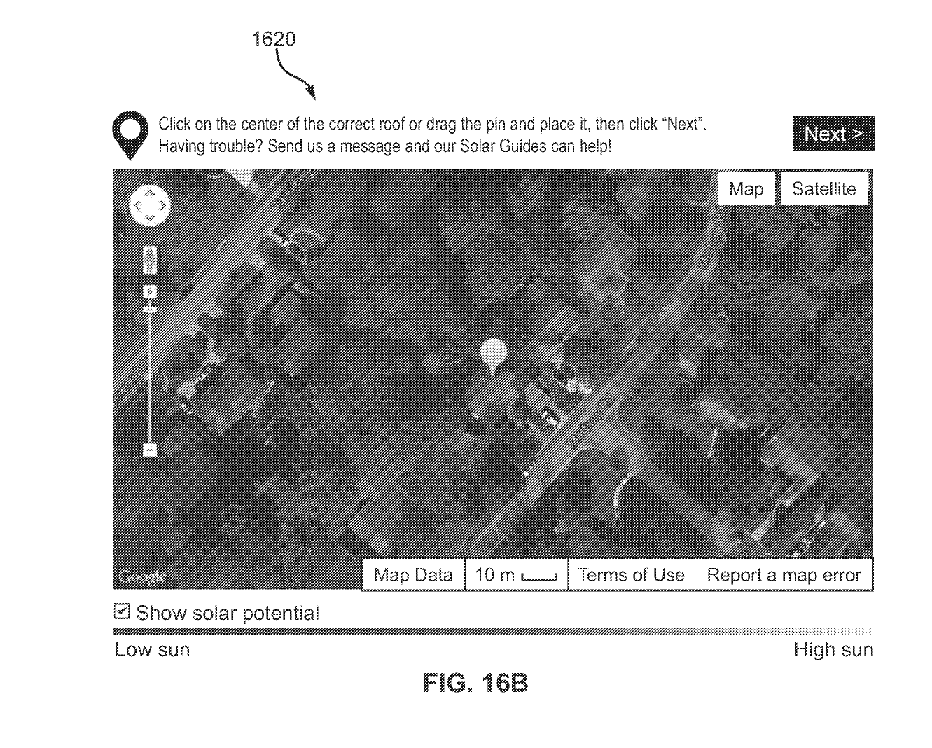

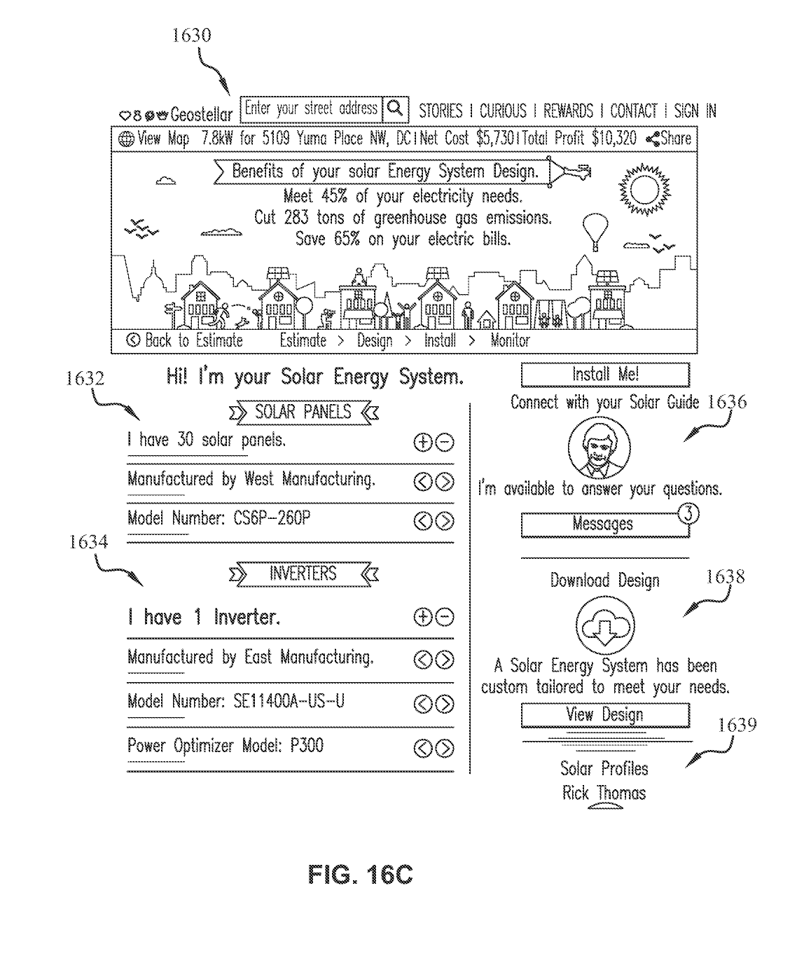

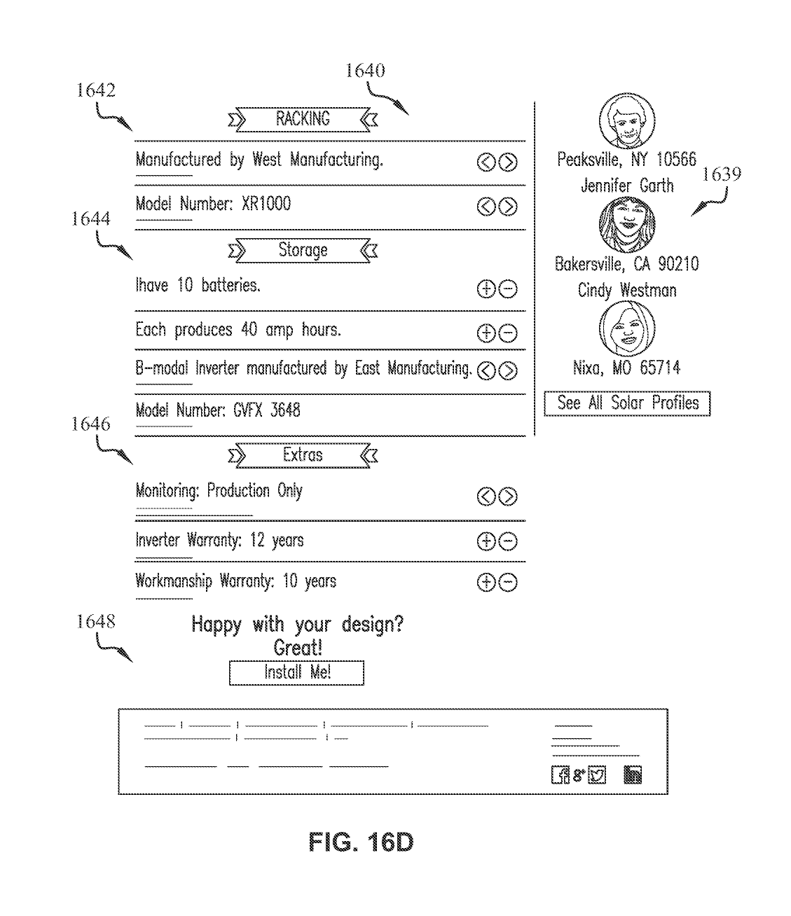

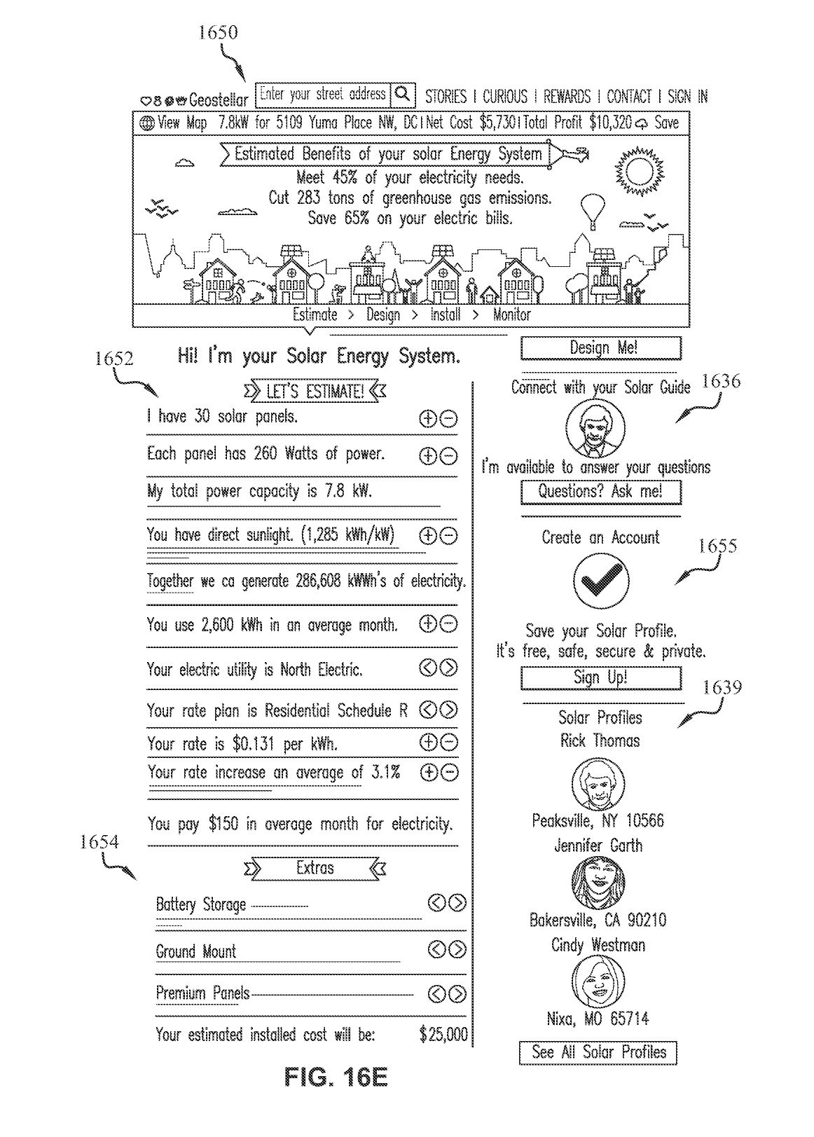

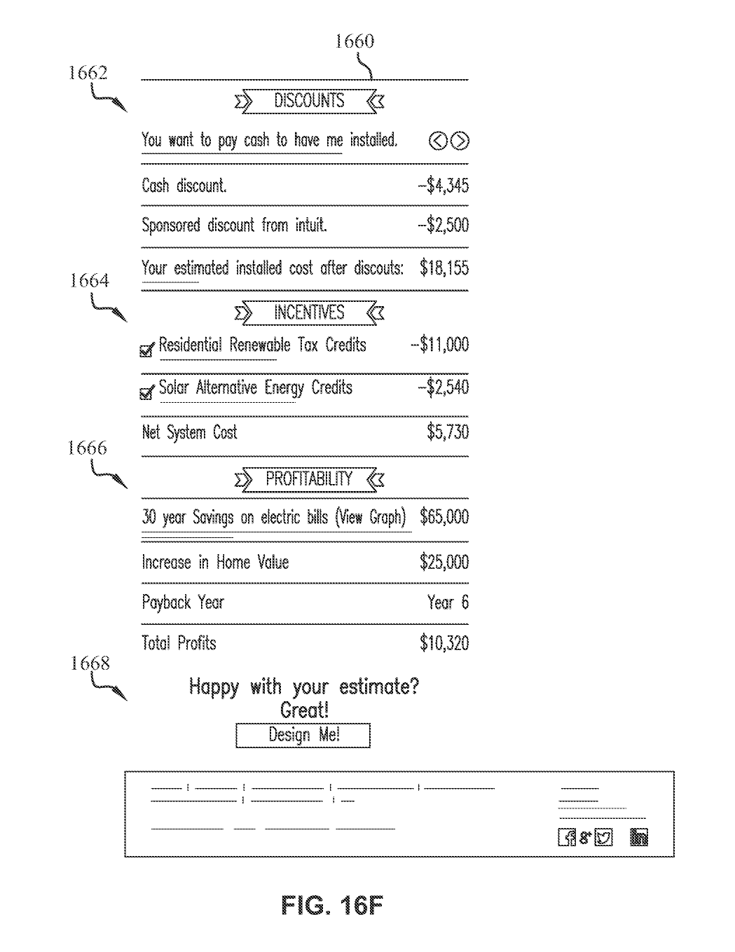

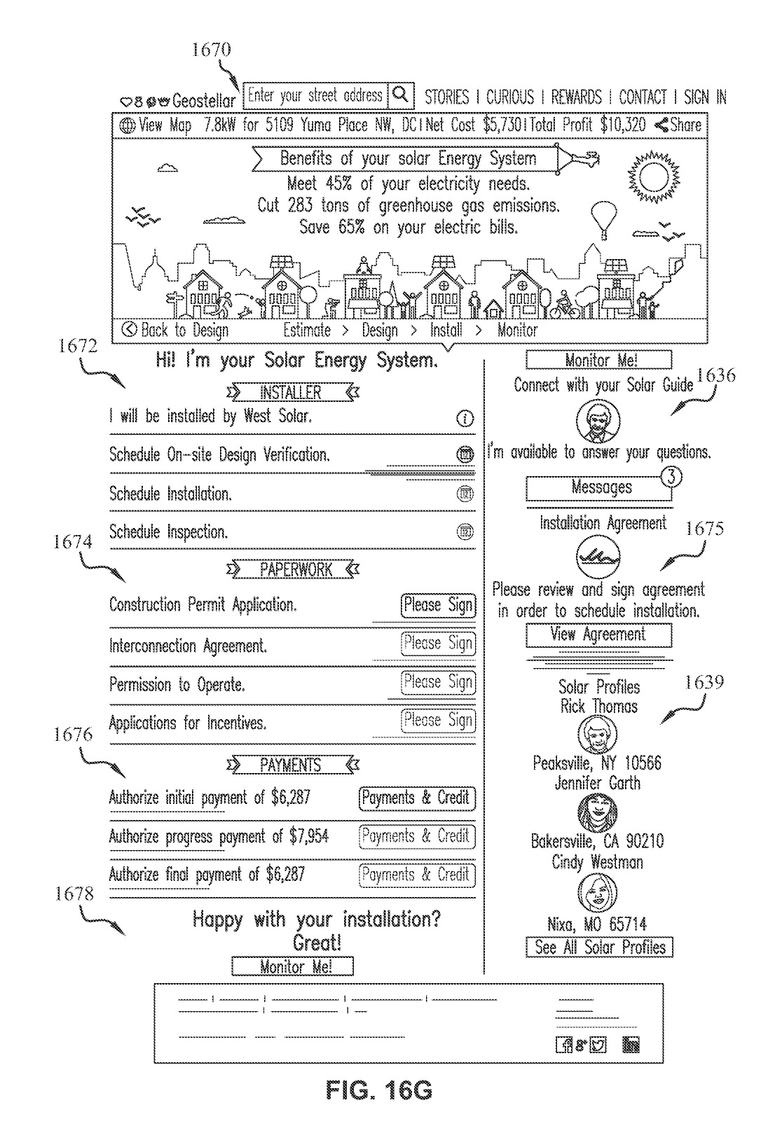

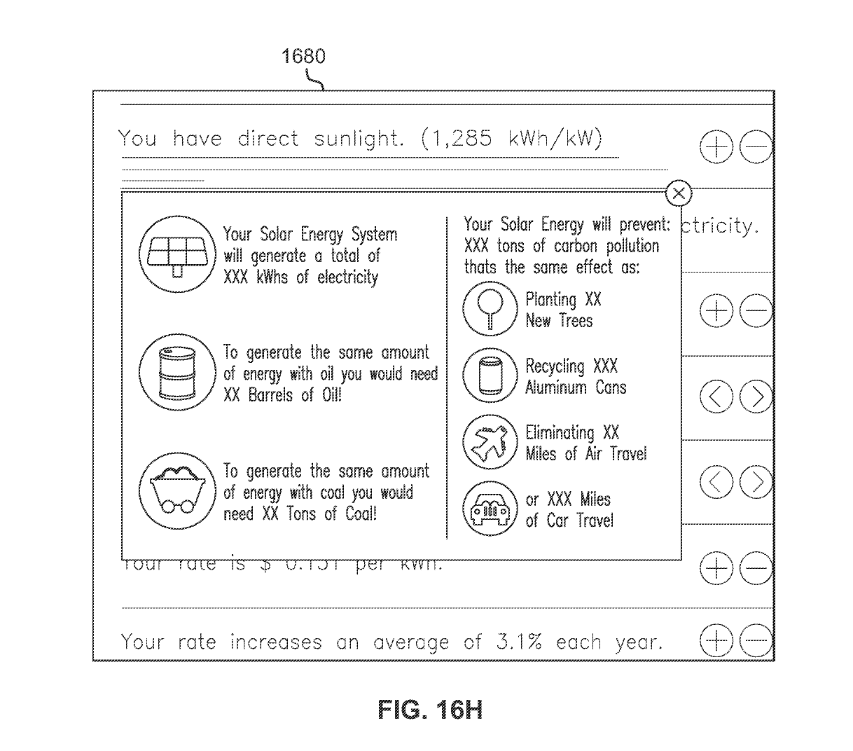

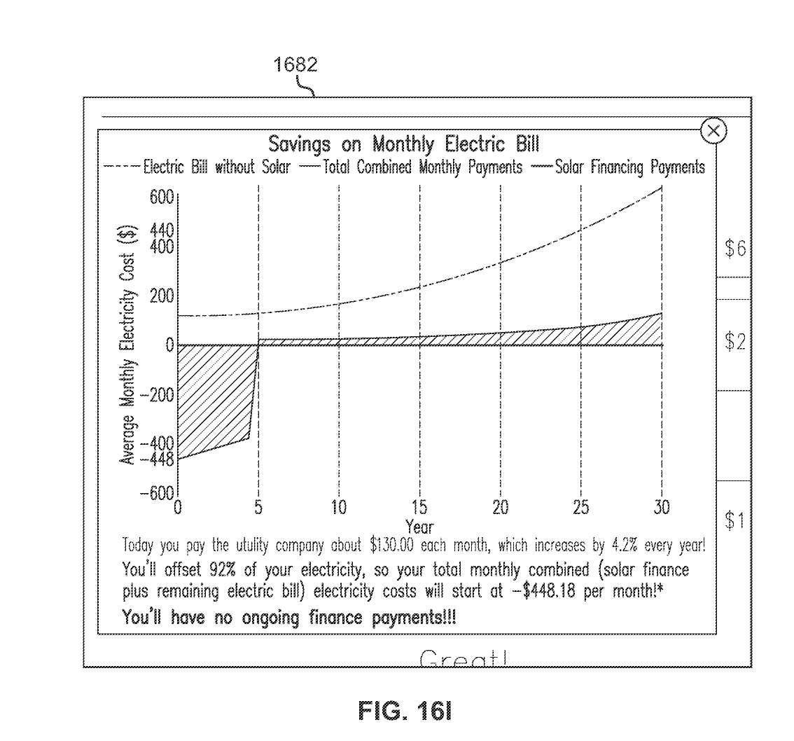

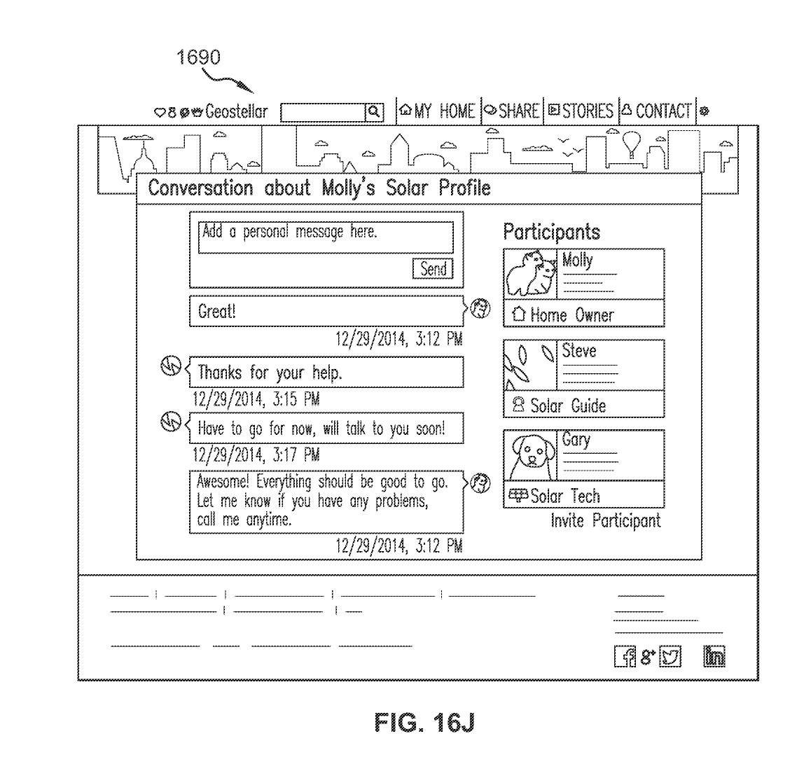

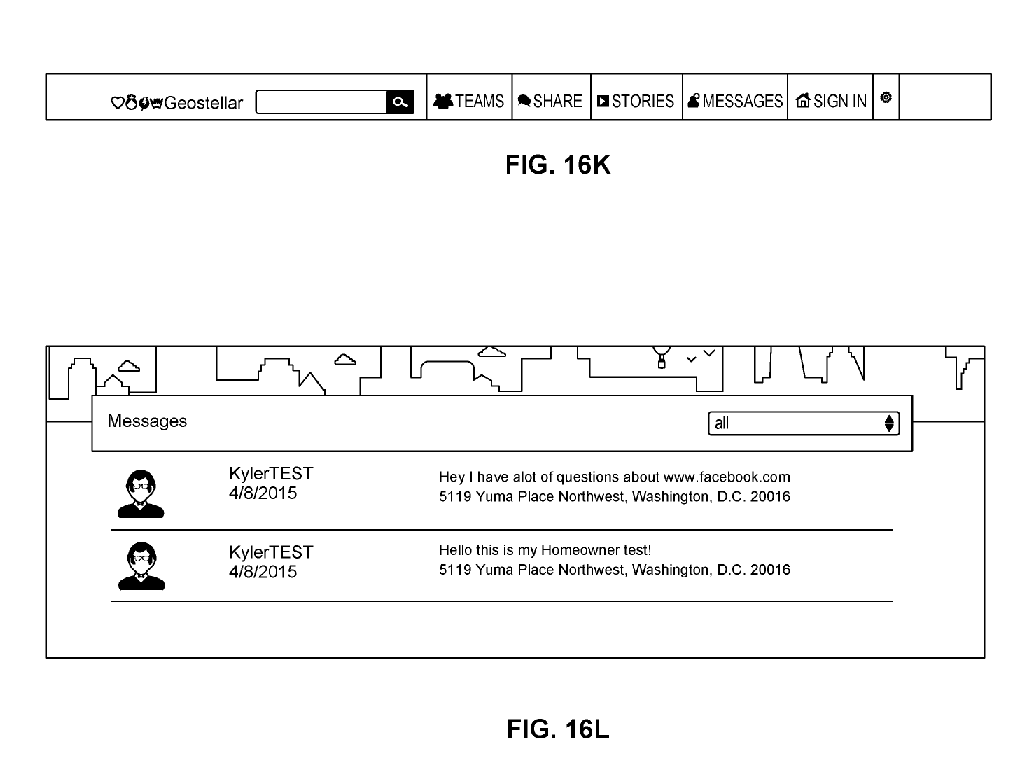

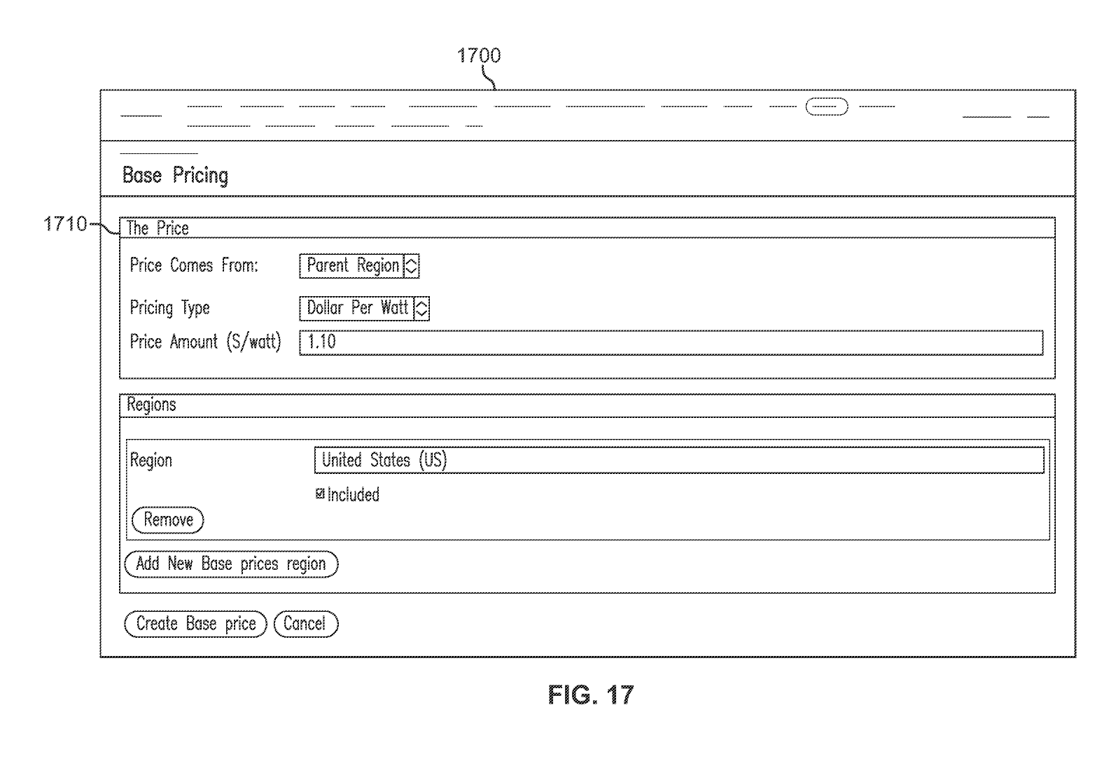

FIG. 16A depicts an example interface 1600 for an online solar marketplace, according to an embodiment. Interface 1600 may include panel 1610 and panel 1615. Panels 1610 and 1615 may include search boxes that enable a user of the online solar marketplace to enter a property address or geolocation. In an embodiment, this location may be submitted to the online solar marketplace for processing in order to determine potential solar energy offerings. In an embodiment, interface 1600 may serve as a landing page for the online solar marketplace.

FIG. 16B depicts a map 1620 illustrating solar potential of a particular region, according to an embodiment. Map 1620 may be generated in response to a geolocation entered by a user, for example, in interface 1600 of FIG. 16A. In an embodiment, solar insolation potential for each property rooftop may be generated from property data collected from a data collection module, such as data collection module 1412 of FIG. 10. An interface module, such as interface module 1424 of FIG. 14, may generate and output map 1620 to a client device for display. In an embodiment, map 1620 enables a user to select a specific property in map 1620.

FIGS. 16C and 16D depict example interfaces 1630 and 1640 for viewing details of a solar energy offering, according to an embodiment. In an embodiment, interfaces 1630 and 1640 may be generated in response to a property selection in map 1620 of FIG. 16B. In another embodiment, interfaces 1630 and 1640 may be generated in response to a submitted geolocation in interface 1600 of FIG. 16A.

Interface 1630 may display details of a solar energy offering and include panels 1632, 1634, 1636, 1638, and 1639. In an embodiment, the solar energy offering may be generated as described previously by determining and comparing available equipment, installation, and financing offerings. Panel 1632 may display solar module (panel) equipment details such as, but not limited to, size of solar array, manufacturer, and model number. Panel 1634 may display inverter equipment details such as, but not limited to, number of inverters, manufacturer, model number, and power optimizer mode. In the example depicted in interface 1630, the solar energy offering includes 30 solar modules (panels) and one inverter. Panel 1636 may enable a user to connect with a solar guide for assistance with the solar energy offering. Panel 1638 may enable a user to save details of the solar energy offering to local storage. Panel 1639 may display relevant solar profiles of other users for comparison purposes. In an embodiment, a solar profile may include details of an installed solar energy system on a particular property.

Interface 1640 may display additional details of the solar energy offering and include panels 1642, 1644, 1646, and 1639. Panel 1642 may display racking equipment details such as, but not limited to, manufacturer and model number. Panel 1644 may display energy storage details such as, but not limited to, number of batteries, battery capacity, manufacturer, and model number. In an embodiment, energy storage may not be included in a solar energy offering. Panel 1646 may display details of system extras such as, but not limited to, solar energy system monitoring, equipment warranties, and installation warranties.

FIGS. 16E and 16F depict example interfaces 1650 and 1660 for entering and altering parameters of a solar energy simulation, according to an embodiment. In an embodiment, for a given solar energy offering, one or more solar energy simulations may be performed as described with respect to FIGS. 3 and 4. Interface 1650 may include panels 1652, 1654, 1636, 1655, and 1639. Panel 1652 may display parameters for a solar energy simulation such as, but not limited to, solar array size, solar module power, calculated direct sunlight to the solar array, average conventional electricity monthly usage, current electric utility provider, current electric utility schedule, current conventional electricity rate (e.g., electricity costs per kWh), estimated conventional electricity annual rate increase, and average conventional electricity monthly cost. In an embodiment, direct sunlight may be calculated by a data collection module, such as data collection module 1412 of FIG. 14, prior to performing the solar energy simulation. Panel 1654 may display additional parameters for a solar energy simulation such as, but not limited to, battery storage, mounting options, and equipment upgrades (e.g., panel upgrades. In an embodiment, each parameter may be altered by a user interacting with interface 1650. A solar energy simulation may be run each time a parameter is altered, or manually after entering or altering one or more parameters. Panel 1655 may enable a user to create an account with the online solar marketplace in order to save details the solar energy offering, solar energy simulation parameters, and solar energy simulation results for later viewing and action.

Interface 1660 may include panels 1662, 1664, and 1666. The options displayed in panels 1662 and 1664 may reduce the installed and monthly energy costs of a solar energy offering through discounts and incentives. Panel 1662 may display financing and discount parameters for the solar energy simulation such as, but not limited to, financing type (e.g., cash, credit, lease, loan, or PPA), financing specific discounts, and promotional discounts. Panel 1664 may display incentive parameters such as, but not limited to, federal and local credits. Panel 1666 may display estimated profitability details such as, but not limited to, savings over a period of time as compared to conventional electricity, increase in property value, the year that the installed cost of the solar energy system may be paid off, and total profits due to installing the solar energy system. In the example depicted in interface 1660, the solar energy offering is estimated to save a property owner $65,000 in electric bills over a 30 year period and increase property value by approximately $25,000. In an embodiment, profitability details may be determined by performing a solar energy simulation.

FIG. 16G depicts an example interface 1670 for viewing and monitoring details of a selected solar energy system installation, according to an embodiment. Once a solar energy offering has been selected by a user, interface 1670 may aggregate installation and administrative details and provide actions to be taken by a user. Interface 1670 may include panels 1672, 1674, 1676, 1678, 1636, 1675, and 1639. Panel 1672 may display actions related to installation to be taken by a user. Panel 1674 may display paperwork required to be completed. Panel 1676 may display required payments to be made. Panel 1678 may enable a user to monitor installation and administrative details associated with the solar energy system. Panel 1675 may enable a user to view an installation agreement associated with installing the solar energy system.

FIG. 16H depicts an example interface 1680 for viewing estimated energy production of a solar energy system, according to an embodiment. Interface 1680 may display results of one or more solar energy simulations run on a solar energy offering such as, but not limited to, estimated total energy produced during a period of time (e.g., 25 years), comparative requirements for energy produced from oil or coal, and carbon dioxide equivalent (CO₂e) prevention due to installation of the solar energy system specified by the solar energy offering. In an embodiment, the estimations displayed in interface 1680 may be derived as described with respect to FIGS. 1-4. In an embodiment, the estimations displayed in interface 1680 may be an average of results generated from a plurality of performed solar energy simulations with different parameters.

FIG. 16I depicts an example interface 1682 for displaying the estimated costs of solar energy compared to conventional electricity costs, according to an embodiment. The estimated costs displayed in interface 1682 may be derived from one or more solar energy simulations run on a solar energy offering. The estimated monthly costs of solar energy may factor in both installed cost and monthly energy costs of the solar energy offering, as described with respect to FIGS. 2-4 and 11. As illustrated in example interface 1682, a graph may be displayed to directly compare the monthly costs of conventional electricity against the estimated monthly costs of solar energy combined with conventional electricity. This may provide a user with a graphical representation of the monthly savings gained by installing a solar energy system. In the example depicted by interface 1682, monthly energy costs based on a particular solar energy offering are estimated to be lower than monthly conventional electricity costs.

FIGS. 16J, 16K, and 16L depict example interfaces for communicating among users of an online solar marketplace, according to an embodiment. Solar energy offerings and solar energy simulations may provide a communications vehicle for various users. For example, a property owner selecting a particular solar energy offering may send messages to and communicate with a representative of the installation provider. In an embodiment, a user may create a solar energy profile including a solar energy offering and one or more solar energy simulations. Conversations may then be initiated based on the solar energy offering or simulations included in the solar profile.

FIG. 17 depicts an example interface 1700 for entering solar energy base pricing information in an online solar marketplace, according to an embodiment. In various embodiments, interface 1700 may be presented to an end user or administrator of the online solar marketplace. Interface 1700 may include panel 1710, which may enable a user to enter estimated conventional electricity pricing information for a particular region. Panel 1710 may include fields such as, but not limited to, price source, pricing type, price amount, and region.

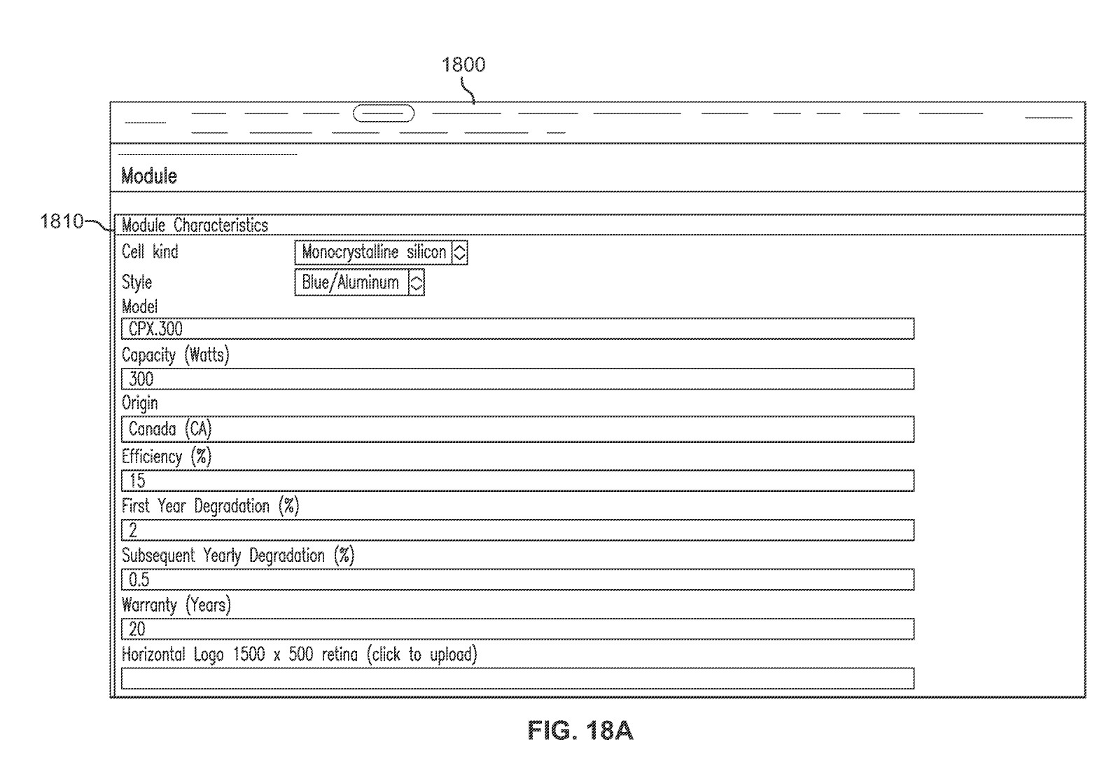

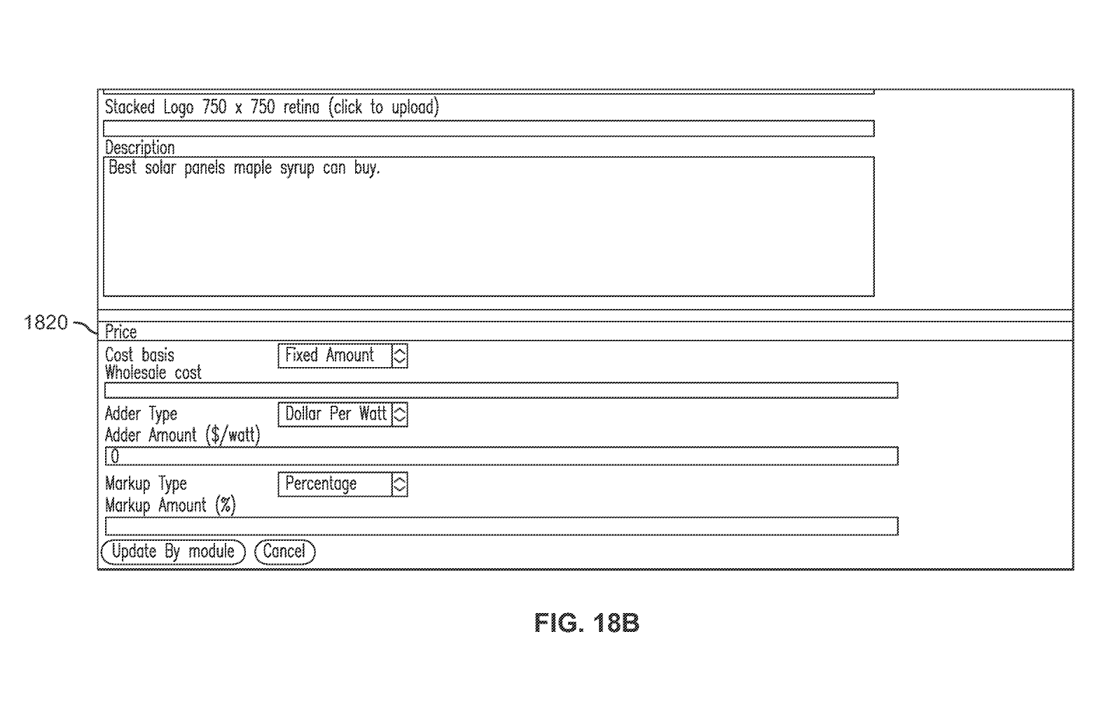

FIGS. 18A and 18B depict example interface 1800 for entering an equipment offering in an online solar marketplace, according to an embodiment. In various embodiments, interface 1800 may be presented to an equipment provider or administrator of the online solar marketplace. Interface 1800 may include panels 1810 and 1820. Panel 1810 may enable a user to enter equipment characteristics. In the example depicted in FIGS. 18A and 18B, a user may be able to enter a solar module (panel) offering. The offering may include equipment characteristics such as, but not limited to, cell type, style, model, capacity, origin, efficiency, first year degradation, subsequent yearly degradation, warranty information, a logo, a stacked logo, and a description. Panel 1820 may enable a user to enter equipment pricing information such as, but not limited to, cost basis, wholesale cost, adder type (e.g., additional cost due to an equipment upgrade), adder amount, markup type, and markup amount. Equipment offerings may be used when determining solar energy offerings, as described with respect to FIGS. 2-4.

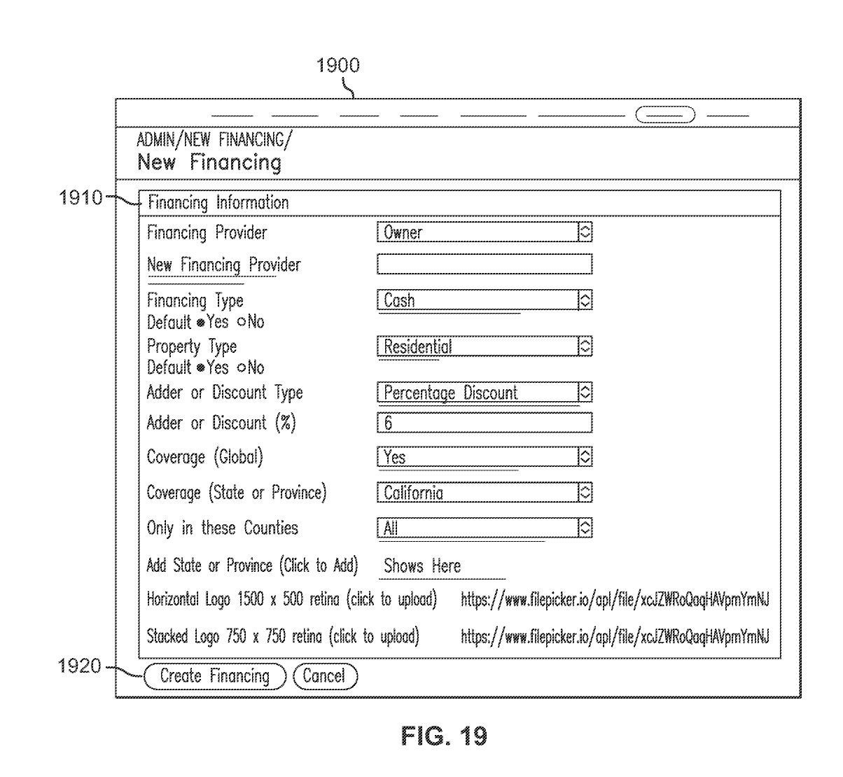

FIG. 19 depicts an example interface 1900 for entering a financing offering in an online solar marketplace, according to an embodiment. In various embodiments, interface 1900 may be presented to a financing provider or administrator of the online solar marketplace. Interface 1900 may include panels 1910 and 1920. Panel 1910 may enable a user to enter details of a financing offering such as, but not limited to, financing provider, name of new financing provider (if required), financing type (e.g., cash, credit, lease, loan, or PPA), property type, adder or discount type, adder or discount amount, global coverage, country-specific coverage, state/province-specific coverage, a horizontal logo, and a stacked logo.

Example interface 1900 depicts a financing type of cash. In an embodiment, additional details may be entered for other financing types. For example, for lease financing, panel 1910 may display details such as, but not limited to, term of lease, description of lease, monthly price per kWh, and marketing payment. For loan financing, panel 1910 may display details such as, but not limited to, term of loan, description of loan, annual percentage rate (APR), and dealer fee. For power purchase agreements (PPAs), panel 1910 may display details such as, but not limited to, term of PPA, description of PPA, price per kWh, and marketing payment.

Panel 1920 may enable a user to submit the entered financing offering to the online marketplace. In an embodiment, this offering may be stored in a marketplace repository, such as marketplace repository 1440 of FIG. 14.

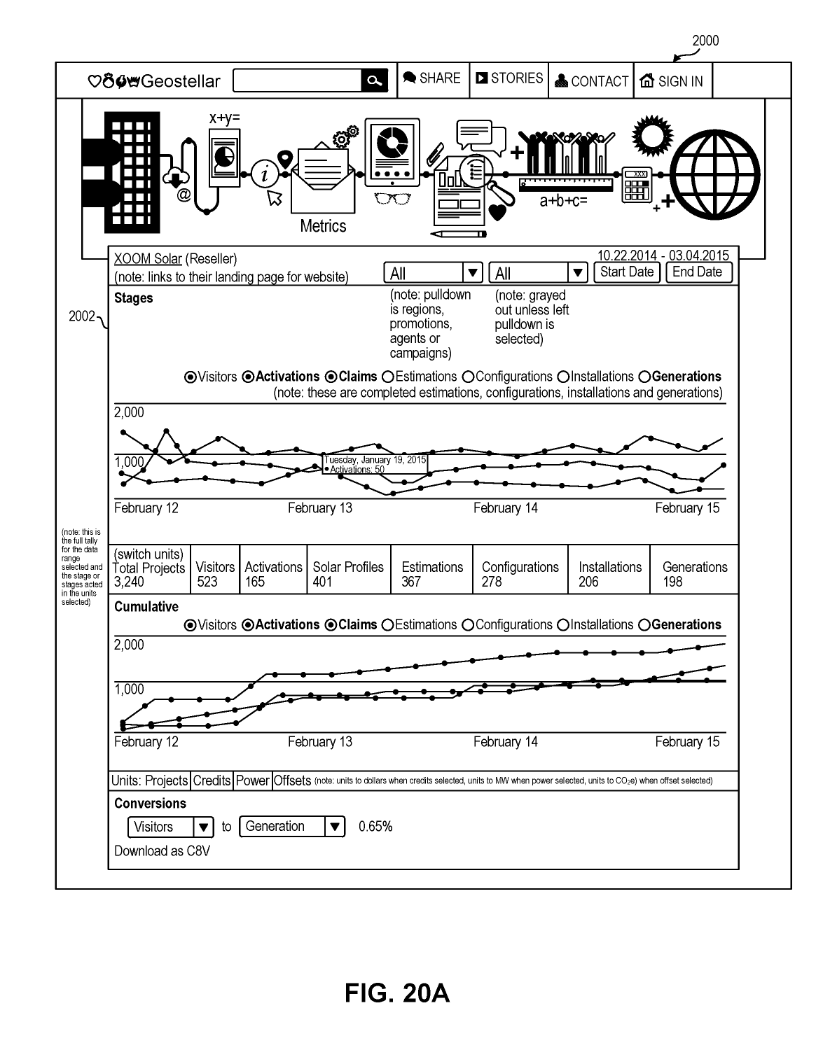

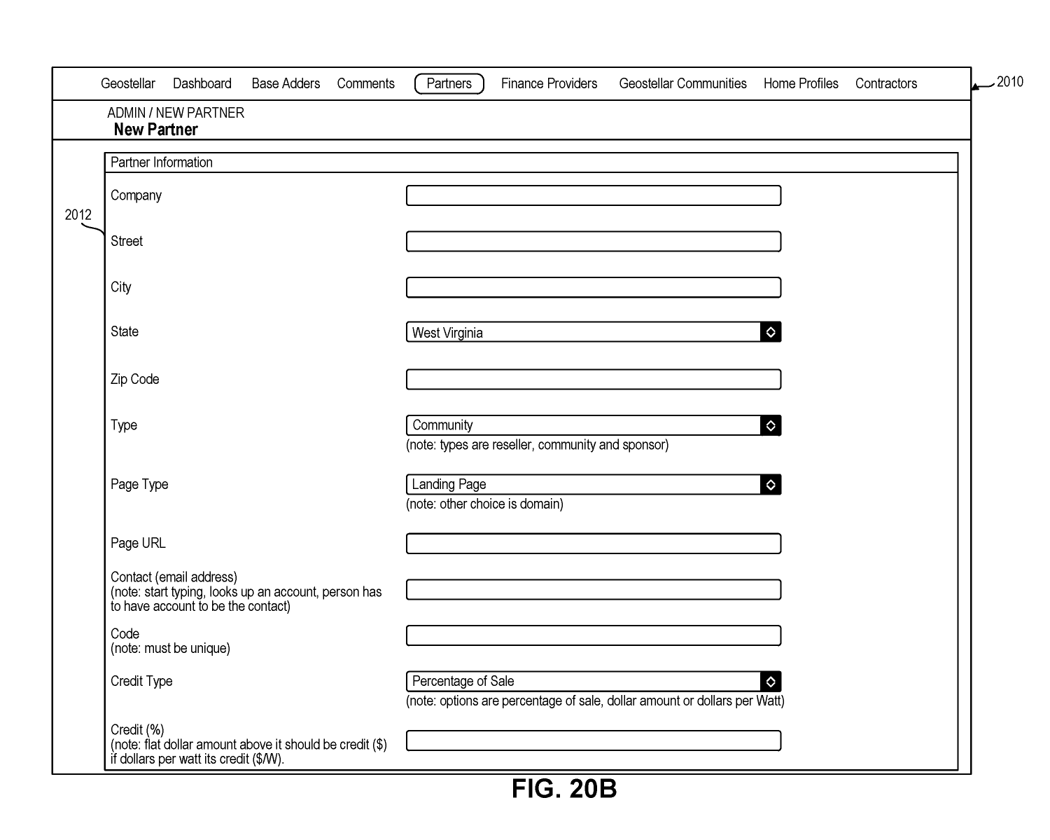

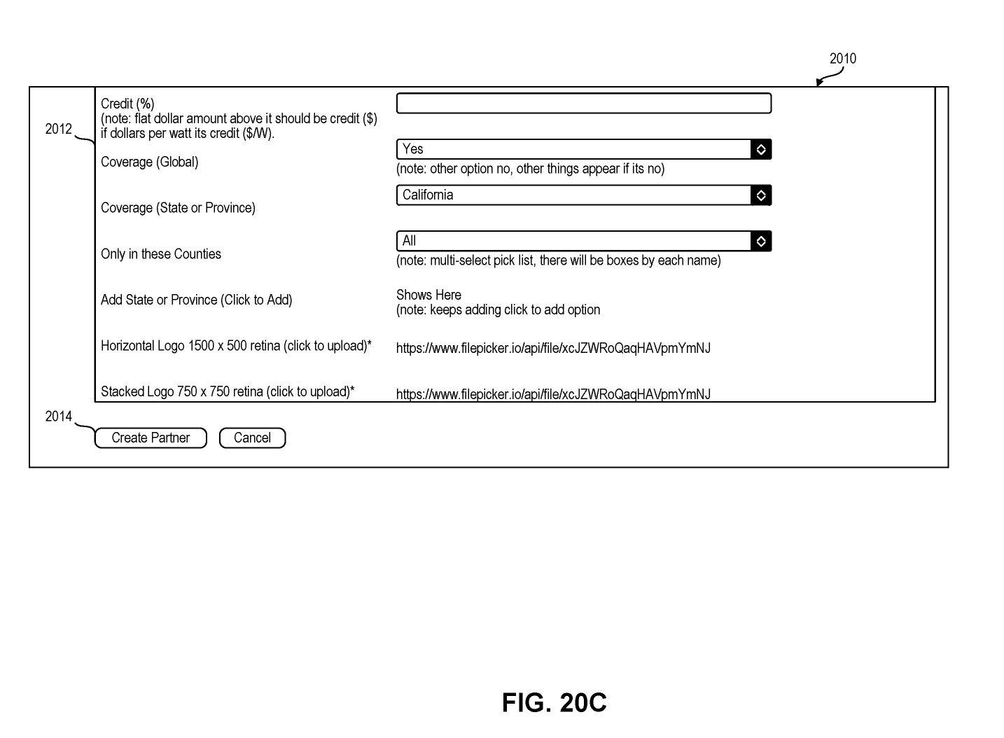

FIG. 20A depicts an example interface 2000 for viewing metrics associated with a partner or sponsor of a solar energy marketplace, according to an embodiment. In an embodiment, interface 2000 may be viewable by a solar energy partner or sponsor, as described with respect to FIGS. 10-13. Interface 2000 may include panel 2002, which may enable a partner or sponsor to view statistics related solar energy campaigns, promotions, and history. In various embodiments, these statistics may include, but are not limited to, total projects initiated, number of visitors viewing the partner or sponsor, number of solar energy activations, and number of installations completed. Different statistics may appear depending on the type of partner or sponsor. For example, as illustrated in FIG. 20A, a reseller may perform installations, while a company sponsor may be more concerned with solar energy activations. In an embodiment, panel 2010 also displays carbon credits, power, and/or carbon offsets generated.

FIGS. 20B and 20C depict an example interface 2020 for adding a partner or sponsor to a solar energy marketplace, according to an embodiment. Interface 2010 may include panels 2012 and 2014. Panel 2012 may enable a user to enter basic information for a solar energy partner or sponsor. In the example provided, this includes company information, credit type (e.g., the partner or sponsor's primary method of compensation), and geographic regions that the partner or sponsor supports. Panel 2014 may enable a user to submit the entered partner or sponsor information to the online marketplace. In an embodiment, partner information may be stored in a marketplace repository, such as marketplace repository 1440 of FIG. 14.

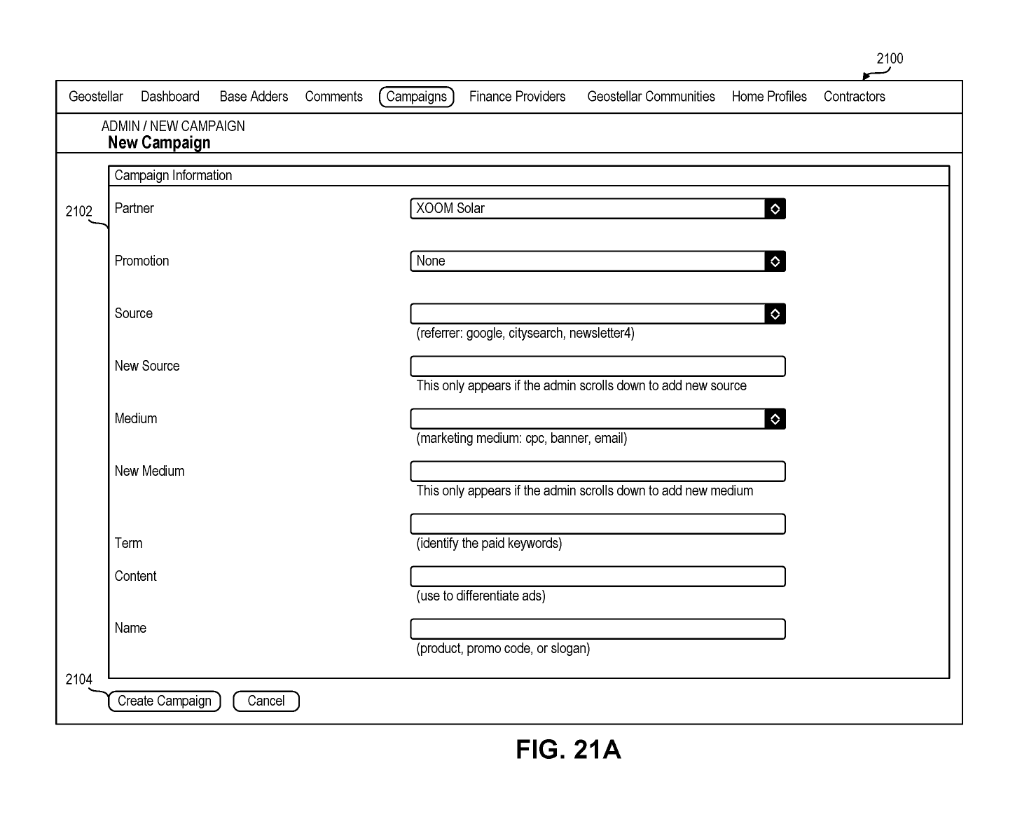

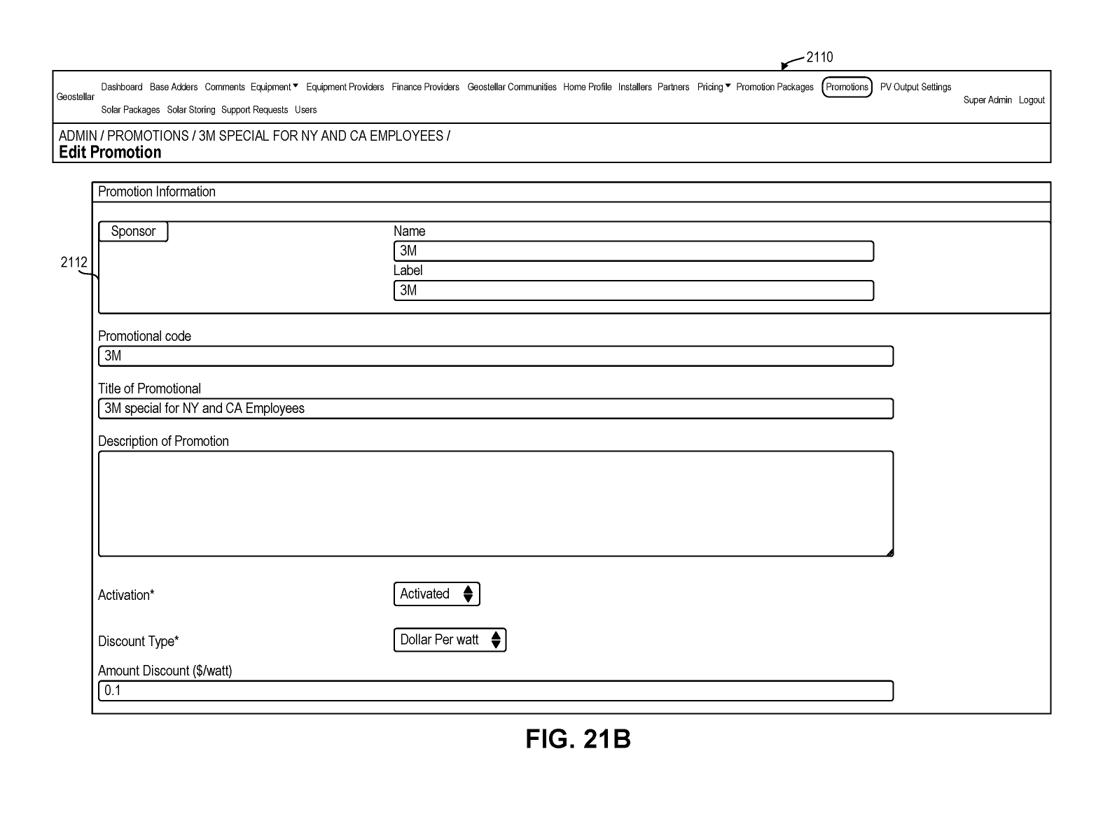

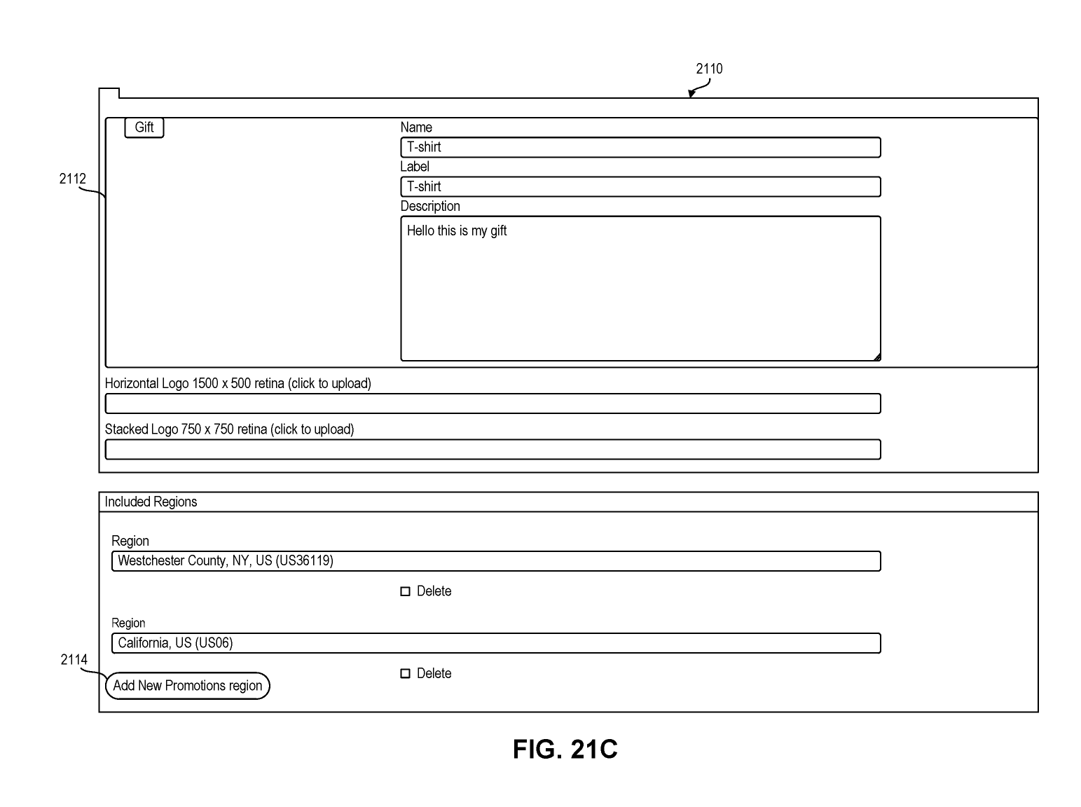

FIG. 21A depicts an example interface 2100 for adding a new campaign to a solar energy marketplace, according to an embodiment. Interface 2100 may include panels 2102 and 2104. Panel 2102 may enable a user to enter campaign information, such as but not limited to, the promotion(s) offered as part of the campaign and the term of the campaign and/or promotion. A promotion selected in interface 2100 may be created in a separate interface, such as interface 2110 of FIGS. 21B and 21C, described further below. Campaigns are described in more detail with respect to FIG. 13. Panel 2104 may enable a user to submit the entered campaign information to the online marketplace. In an embodiment, campaign information may be stored in a marketplace repository, such as marketplace repository 1440 of FIG. 14.

FIGS. 21B and 21C depict an example interface 2110 for entering promotions into a solar energy marketplace, according to an embodiment. Interface 2110 may include panels 2112 and 2114. Sponsor promotions are intended to encourage solar energy adoption and benefit property owners by offering incentives to adopt solar energy, as described above with respect to FIGS. 11-14. Panel 2112 may enable a user to enter promotion information, such as but not limited to, title of promotion, discount type and amount of discount (if applicable), gift (if applicable), and included regions where the promotion will apply. Panel 2114 may enable a user to submit the entered promotion information to the online marketplace. In an embodiment, promotion information may be stored in a marketplace repository, such as marketplace repository 1440 of FIG. 14.

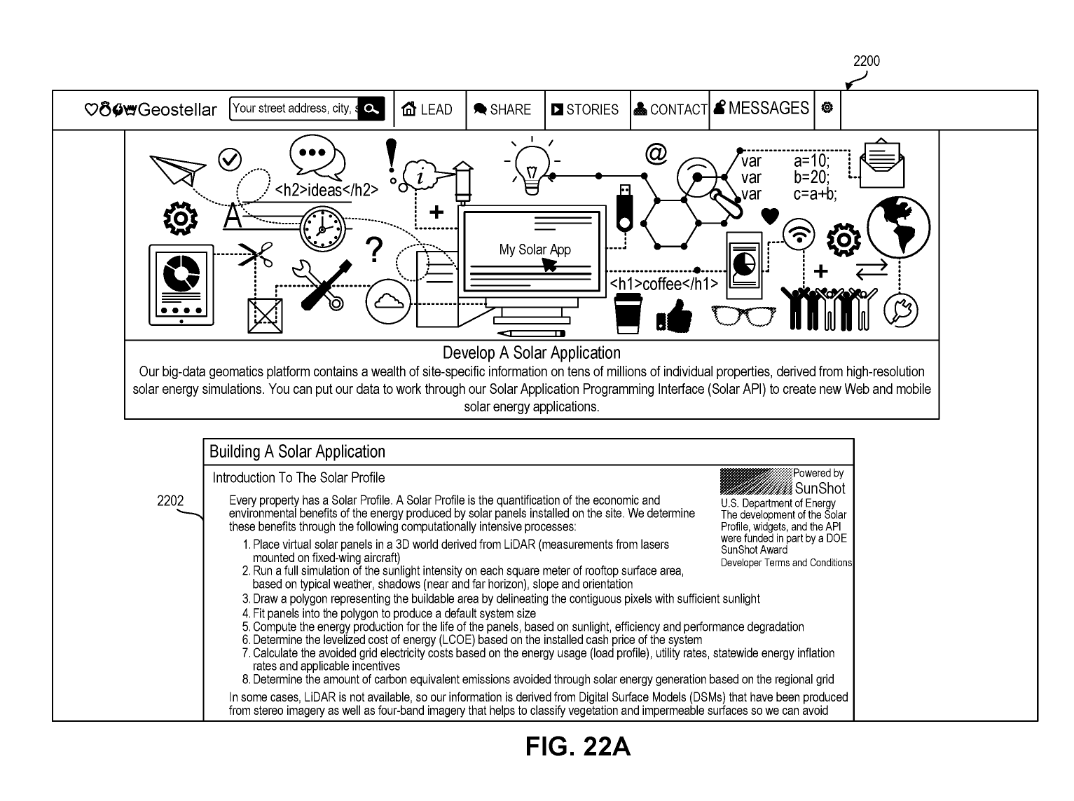

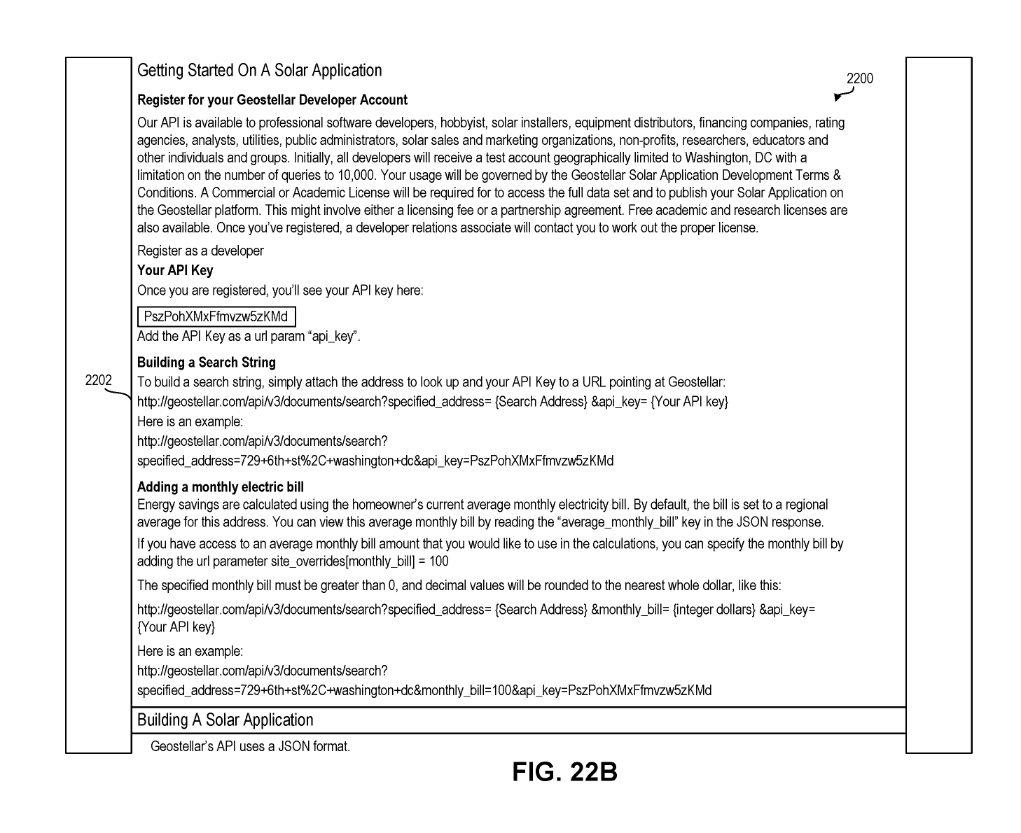

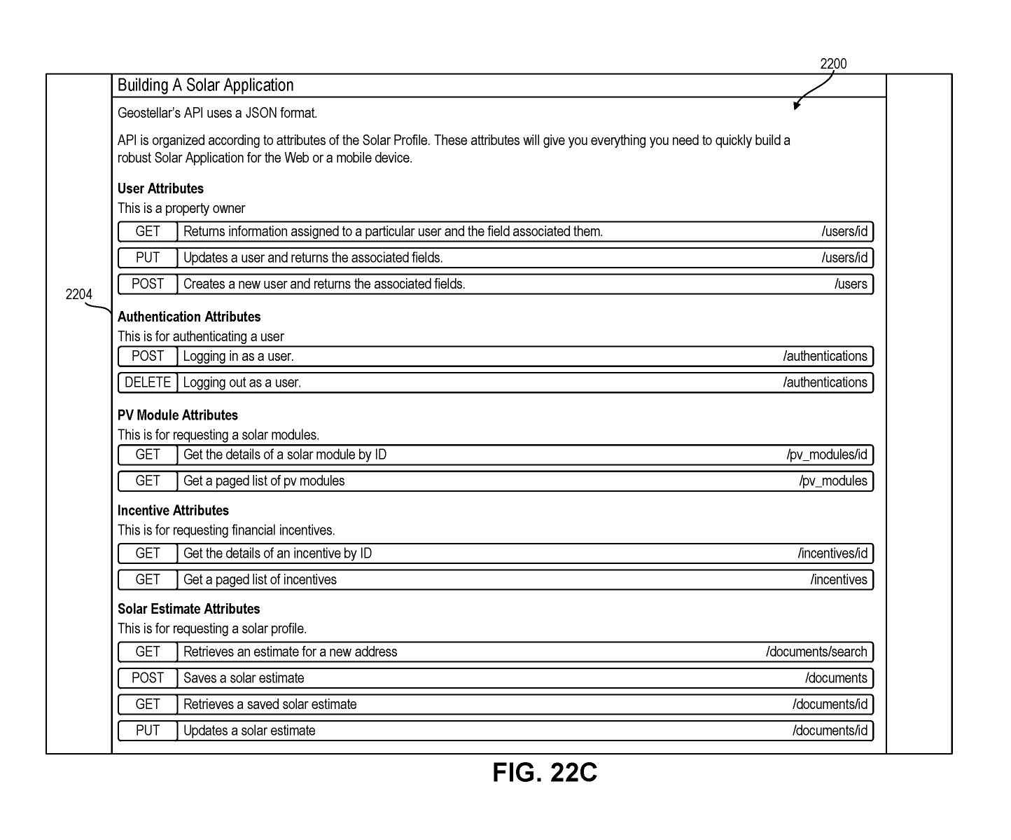

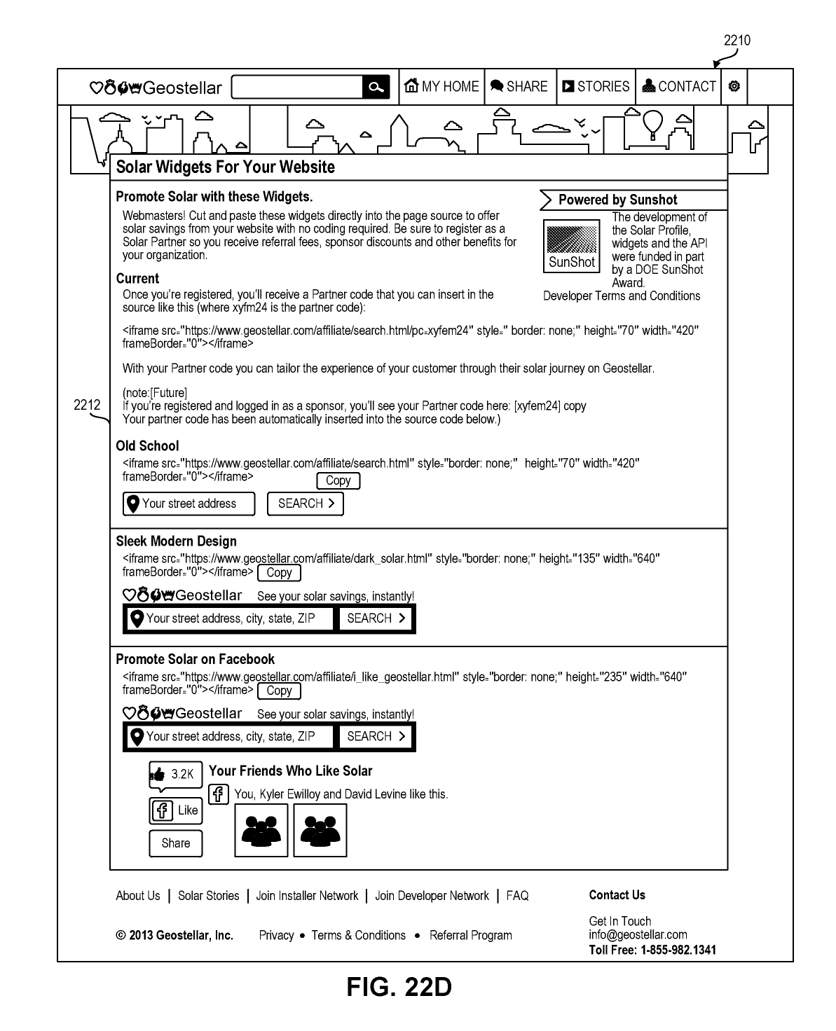

FIGS. 22A, 22B, 22C, and 22D illustrate use of an application programming interface (API) for a solar energy marketplace, according to an embodiment. Interface 2200 may include panels 2202 and 2204. Panel 2202 describes use of an API to create solar energy applications on top of the solar energy marketplace. This allows third party applications to take advantage of the marketplace platform and access simulation and other solar-energy related data. For example, a sponsor may use this API to create an application or web site that offers solar energy to its customers and employees. A solar energy equipment, financing, or installation provider may similarly use the API to create white label applications that facilitate solar energy adoption. Panel 2204, as illustrated in FIG. 22C, provides API details, according to an embodiment. For example, panel 22C provides query access via the API to retrieve data such as solar module details, incentive details, and solar energy estimates by address or geolocation. Panel 2204 specifies that query results are returned in JavaScript Object Notation (JSON), but one of skill in the art will appreciate that API query results may be returned in any structured or unstructured format.

Interface 2210 may include panel 2212. In an embodiment, Panel 2212 provides web site widgets that may be incorporated into third party web sites and applications. These widgets may allow a developer to take advantage of the marketplace API using prewritten code snippets. As illustrated in FIG. 22D, an example widget enables a user to obtain solar energy information for a particular address from a third party web site or application.

### CONCLUSION

Identifiers, such as “(a),” “(b),” “(i),” “(ii),” etc., are sometimes used for different elements or steps. These identifiers are used for clarity and do not necessarily designate an order for the elements or steps.

Embodiments of the present inventions have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the inventions that others can, by applying knowledge within the skill of the art, readily modify and/or adapt for various applications such specific embodiments, without undue experimentation, without departing from the general concept of the present inventions. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present inventions should not be limited by any of the above-described embodiments, but should be defined only in accordance with the following claims and their equivalents.

What is claimed is:

1. A system for facilitating generation of carbon credits to offset greenhouse gas emissions, comprising:
one or more computing devices;
a marketplace repository storing simulated and actual solar energy production for a plurality of properties;
an incentives module, implemented on the one or more computing devices, configured to:
receive one or more carbon emissions reduction targets from a sponsor for a defined time period;
initiate a campaign for the sponsor including a sponsor promotion and a plurality of targeted properties or regions;
adjust the promotion for each targeted property based on estimated energy production for the property compared to an average solar energy production per targeted property;
a simulation module, implemented on the one or more computing devices, configured to run one or more broad market simulations on the targeted properties or regions to estimate the average solar energy production per targeted property;
a pricing module, implemented on the one or more computing devices, configured to facilitate installation of solar energy systems on one or more of the targeted properties;
a monitoring module, implemented on the one or more computing devices, configured to monitor the solar energy production of each installed solar energy system,
wherein the incentives module is further configured to provide carbon credits to the sponsor that correspond to the amount of carbon dioxide equivalent (CO₂e) reduction attributed to each installed solar energy system.

2. The system of claim 1, wherein the received carbon emissions reduction targets include scope 1, scope 2, and scope 3 greenhouse gas emissions.

3. The system of claim 1, wherein the simulation module is further configured to run the one or more broad market simulations on specific properties or regions identified by the sponsor.

4. The system of claim 1, wherein the simulation module is further configured to run the one or more broad market simulations on a general sample of the targeted plurality of properties or regions.

5. The system of claim 1, wherein the monitoring module is further configured to:
receive solar energy production measurements from one or more solar inverters of the solar energy system, wherein the energy production values indicate solar energy converted by the one or more solar inverters;
receive solar energy production measurements from one or more electricity meters coupled to the solar energy system, wherein the electricity meters track the flow of energy from the one or more solar inverters;
compare the solar energy production measurements from the solar inverters to the solar energy production measurements from the electricity meters to ensure accuracy of the received measurements; and
write the received solar energy production measurements to the marketplace repository.

6. The system of claim 1, wherein the incentives module is further configured to register the produced solar energy for each installed solar energy system with a carbon offset registry to generate carbon credits.

7. The system of claim 1, further comprising:
an interface module, implemented on the one or more computing devices, configured to output an indication of the provided carbon credits compared to the received carbon emissions reduction targets for display to the sponsor.

8. A computer-implemented method for facilitating generation of carbon credits to offset greenhouse gas emissions, comprising:
receiving one or more carbon emissions reduction targets from a sponsor for a defined time period;
initiating a campaign for the sponsor including a sponsor promotion and a plurality of targeted properties or regions;
running one or more broad market simulations on the plurality of targeted properties or regions to estimate an average solar energy production per property;
adjusting the promotion for each targeted property based on the property's estimated energy production compared to the average solar energy production;
facilitating installation of solar energy systems on one or more of the targeted properties;
monitoring the solar energy production of each installed solar energy system; and
providing carbon credits to the sponsor that correspond to the amount of carbon dioxide equivalent (CO₂e) reduction attributed to each installed solar energy system.

9. The method of claim 8, wherein the received carbon emissions reduction targets include scope 1, scope 2, and scope 3 greenhouse gas emissions.

10. The method of claim 8, wherein the one or more broad market simulations are run on specific properties or regions identified by the sponsor.

11. The method of claim 8, wherein the one or more broad market simulations are run on a general sample of the targeted plurality of properties or regions.

12. The method of claim 8, wherein the monitoring further comprises, for each installed solar energy system:
receiving solar energy production measurements from one or more solar inverters of the solar energy system, wherein the energy production values indicate solar energy converted by the one or more solar inverters;
receiving solar energy production measurements from one or more electricity meters coupled to the solar energy system, wherein the electricity meters track the flow of energy from the one or more solar inverters; and
comparing the solar energy production measurements from the solar inverters to the solar energy production measurements from the electricity meters to ensure accuracy of the received measurements.

13. The method of claim 8, wherein the providing further comprises:
registering the produced solar energy for each installed solar energy system with a carbon offset registry to generate carbon credits;
providing the generated carbon credits to the sponsor.

14. The method of claim 8, further comprising outputting an indication of the provided carbon credits compared to the received carbon emissions reduction targets for display to the sponsor.

15. A non-transitory computer-readable storage device having instructions stored thereon that, when executed by at least one computing device, causes the at least one computing device to perform operations comprising:
receiving one or more carbon emissions reduction targets from a sponsor for a defined time period;
initiating a campaign for the sponsor including a sponsor promotion and a plurality of targeted properties or regions;
running one or more broad market simulations on the plurality of targeted properties or regions to estimate an average solar energy production per property;
adjusting the promotion for each targeted property based on the property's estimated energy production compared to the average solar energy production;
facilitating installation of solar energy systems on one or more of the targeted properties;
monitoring the solar energy production of each installed solar energy system; and
providing carbon credits to the sponsor that correspond to the amount of carbon dioxide equivalent (CO₂e) reduction attributed to each installed solar energy system.

16. The non-transitory computer-readable storage device of claim 15, wherein the received carbon emissions reduction targets include scope 1, scope 2, and scope 3 greenhouse gas emissions.

17. The non-transitory computer-readable storage device of claim 8, wherein the one or more broad market simulations are run on specific properties or regions identified by the sponsor.

18. The non-transitory computer-readable storage device of claim 15, wherein the one or more broad market simulations are run on a general sample of the targeted plurality of properties or regions.

19. The non-transitory computer-readable storage device of claim 15, wherein the monitoring further comprises, for each installed solar energy system:
receiving solar energy production measurements from one or more solar inverters of the solar energy system, wherein the energy production values indicate solar energy converted by the one or more solar inverters;
receiving solar energy production measurements from one or more electricity meters coupled to the solar energy system, wherein the electricity meters track the flow of energy from the one or more solar inverters; and
comparing the solar energy production measurements from the solar inverters to the solar energy production measurements from the electricity meters to ensure accuracy of the received measurements.

20. The non-transitory computer-readable storage device of claim 15, wherein the providing further comprises:
registering the produced solar energy for each installed solar energy system with a carbon offset registry to generate carbon credits;
providing the generated carbon credits to the sponsor.
